(19) United States
(12) Patent Application Publication
(10) Pub. No.: US 2019/0057233 A1
(43) Pub. Date: Feb. 21, 2019

(54) Detection and tracking system using tattoos

(71) Applicant: Lawrence Livermore National Security, LLC, Livermore, CA (US)

(72) Inventors: Eddie E. Scott, Danville, CA (US); Ronald J. Kane, Livermore, CA (US); John T. Chang, Danville, CA (US)

(73) Assignee: Lawrence Livermore National Security, LLC, Livermore, CA (US)

(21) Appl. No.: 15/999,223

(22) Filed: Aug. 15, 2018

Related U.S. Application Data
(60) Provisional application No. 62/545,938, filed on Aug. 15, 2017.

(51) Int. Cl. G06K 7/14; G06K 9/00

(52) U.S. Cl. CPC G06K 7/1482; G06K 9/0055; G06K 9/00228; G06T 7/246; G06K 9/00778; G06K 9/00288; G06K 9/00362

(57) ABSTRACT

Improved tattoo recognition and improved individual recognition and tracking by directing energy onto an individual's tattoo or onto tissue proximate the individual's tattoo thereby producing a signal with enhanced information about the individual's tattoo. The signal with enhanced information about the individual's tattoo is used to match the individual with stored images in a tattoo database or databases. The signal with enhanced information about the individual's tattoo is combined with biometric systems to improve reliability and dependability of identifying, tracking, and/or monitoring individuals.

### CROSS-REFERENCE TO RELATED APPLICATIONS

This application claims the benefit of U.S. Provisional Patent Application No. 62/545,938 titled “Detection and Tracking System Using Tattoos,” filed Aug. 15, 2017, incorporated herein by reference.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC, for the operation of Lawrence Livermore National Laboratory.

### BACKGROUND OF THE INVENTION

### Field of the Invention

The present application relates to individual recognition systems, and more particularly to enhancing tattoo recognition systems.

### Description of Related Art

Agencies such as the FBI and counterpart international agencies normally require more than a dozen agents to track a single individual. With the increasing large numbers of suspected terrorists and criminals there is not enough manpower effectively accomplish the needs. Automated systems are needed that are highly reliable and effective. Hospitals, care facilities, and home emergency alert system also need automated patient monitoring systems that are highly reliable and cost effective. A patient's medical condition can trigger wandering tendencies that can have catastrophic effects such as injury to self, injury to other patients; injury to staff; injury to the public; and adverse effects including tarnished hospital reputation, liability and litigation costs, jeopardy citations, loss of Medicaid and Medicare reimbursements, spread of infection, and other adverse effects. Automated systems that are highly reliable and cost effective are needed for detecting an emergency of patient at home. Patients in these circumstances are willing to be tattooed (voluntary tattoos) with temporary or permanent tattoos and will consent to the tattooing can benefit from improved patient care and medical outcome.

The Jan. 19, 2010 article, “MSU Licenses Tattoo Matching Technology to World's Leading Biometrics Company,” at http://news.msu.edu/story/7317/(news release), provides the following state of technology information. “Michigan State University has licensed its unique tattoo matching technology to MorphoTrak, the world's top provider of biometric and identity management systems. With this innovative technology, the corrections and law enforcement community will now have the capability to accurately and efficiently search tattoo image databases to identify suspects, criminals and victims. This content-based image retrieval and matching technology uses features such as color, shape and texture present in tattoo images, instead of labels or keywords, to compute the similarity between images. This technology is an invaluable tool to assist law enforcement with intelligence gathering for suspect and victim identification. We trust MorphoTrak to bring this technology to bear at all levels of the law enforcement community,” said Jain.”

The article in the Jun. 3, 2016 issue of Newsweek titled: “FBI Develops Tattoo Tracking technology” provides the state of technology information reproduced as follows. “The FBI is working with researchers to develop tattoo-recognition technology capable of profiling people by their religion, gang affiliation or political ideology, a report has revealed.” “Tattoos have been used for many years to assist law enforcement in the identification of criminals and victims and for investigative research purposes,” NIST states on its website: Tattoos provide valuable information on an individual's affiliations or beliefs and can support identity verification of an individual.” “The technology is already being deployed across the state of Indiana by police forces, while EFF's report also claims that companies, including MorphoTrak and DataWorks, are offering tattoo recognition as part of biometric software packages.”

The September 2016 publication, NISTIR 8109, “Tattoo Recognition Technology-Best Practices,” by Mei Ngan, George W. Quinn, and Patrick Grother, provides the following state of technology information. “The Tattoo Recognition Technology Program was organized by NIST to provide a measurement and testing foundation to support law enforcement needs and applications for image-based tattoo recognition. The program provides quantitative support for tattoo recognition development and best practice guidelines.”

### SUMMARY OF THE INVENTION

Features and advantages of the disclosed apparatus, systems and methods will become apparent from the following description. Applicant is providing this description, which includes drawings and examples of specific embodiments, to give a broad representation of the apparatus, systems and methods. Various changes and modifications within the spirit and scope of the application will become apparent to those skilled in the art from this description and by practice of the apparatus, systems and methods. The scope of the apparatus, systems and methods is not intended to be limited to the particular forms disclosed and the application covers all modifications, equivalents, and alternatives falling within the spirit and scope of the apparatus, systems and methods as defined by the claims.

The inventor's apparatus, systems, and methods provide improved tattoo recognition and improved individual recognition and tracking. In basic embodiments the disclosed apparatus, systems and methods directs energy onto the individual's tattoo or onto tissue proximate the individual's tattoo thereby producing a signal with enhanced information about the individual's tattoo. The signal with enhanced information about the individual's tattoo is used to match the individual with stored images in a tattoo database or databases.

The inventor's apparatus, systems, and methods also provide improved individual recognition and tracking using the enhanced information about the individual's tattoo by combining the tattoo database system with biometric systems to improve reliability and dependability of identifying, tracking, and/or monitoring individuals. For example, the inventor's apparatus, systems, and methods can be combined with artificial intelligence systems, facial recognition systems, next generation identification systems, finger prints identification systems, palm print identification systems, eye scan systems, machine learning systems, and other biometric systems to improve reliability and dependability of the identifying, tracking, and/or monitoring.

In basic embodiments the inventor's apparatus, systems, and methods can recognize an individual that has a tattoo using a database of known tattoos by directing energy onto or proximate the tattoo producing a signal with an enhanced image of the individual's tattoo; detecting the signal using a detecting system; and comparing the enhanced image of the individual's tattoo with the known tattoos in the tattoo database thereby recognizing the individual if the individual's tattoo matches a known tattoo in the tattoo database.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

In some embodiments, radar systems use the scattered signal from a target for localizing it in space and time. A feature of this scattering process is that the target scattering as a function of viewing angle is affected by the RF wavelength. RF polarization, conductive properties and the shape of the scattering object. These interactions enable a radar-like interrogation process to be used to obtain scattering features related to the tattoo. Scattering is a function of several factors, including tattoo conductivity-contrast against the tissue.

At the “other end” of the electromagnetic spectrum within the current scope of technology is the use of photonic approaches for interrogation and identification. Embodiments of the present invention illuminate the area of the tattoo with a raster-scanning technique using a low power laser of variable wavelength. The scattered photons can be used to identify the constituents of the tattoo inks using spectroscopy. Knowledge of the constituent locations enables tattoo identification.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIGS. 1A, 1B, 1C, and 1D illustrate different types, sizes, and shapes of tattoos located at different locations on individual's bodies.

FIGS. 2A, 2B, and 2C illustrate embodiments of the inventors' apparatus, systems and methods.

FIG. 3 illustrates an embodiment of the inventors' apparatus, systems and methods tracking an individual in a group of people.

FIG. 4 illustrates an embodiment of the inventors' apparatus, systems and methods wherein tattoos are covered by clothing.

FIG. 5 illustrates an embodiment of the inventors' apparatus, systems and methods wherein a group of people are monitored from a drone.

FIG. 6 illustrates an embodiment of the inventors' apparatus, systems and methods wherein a group of people are monitored from an airplane.

FIG. 7 illustrates an embodiment of the inventors' apparatus, systems and methods wherein a group of people are monitored from a satellite.

FIG. 8 illustrates an embodiment wherein a robbery in progress is being monitored by the inventors' apparatus, systems and methods.

FIG. 9 illustrates an embodiment wherein an individual is being monitored in a security booth by the inventors' apparatus, systems and methods.

FIGS. 10A and 10B illustrate an embodiment wherein a group of prisoners are being identified and tracked by the inventors' apparatus, systems and methods.

FIGS. 11A and 11B illustrate an embodiment wherein a group of terrorists are being identified and tracked by the inventors' apparatus, systems and methods.

FIG. 12 illustrates an embodiment wherein a system for tracking an individual having a tattoo is combined with a system for tracking an individual inside of a building.

FIG. 13 illustrates an embodiment wherein a system for tracking an individual using a tattoo is combined with a machine learning system.

FIG. 14 illustrates an embodiment of the inventors' apparatus, systems and methods wherein a signal from a tattoo is enhanced.

FIG. 15 illustrates a system for tracking a patient using a tattoo on the patient's skin and an energy source.

FIG. 16 illustrates a system for monitoring and tracking an individual with Alzheimer disease, dementia, or other debilitating disease using a tattoo on the individual's skin and an energy source.

FIG. 17 illustrates a medical alert system for monitoring and tracking an individual living at home using a tattoo on the individual's skin and an energy source.

### DETAILED DESCRIPTION OF THE INVENTION

Referring to the drawings, to the following detailed description, and to incorporated materials, detailed information about the apparatus, systems and methods is provided including the description of specific embodiments. The detailed description serves to explain the principles of the apparatus, systems and methods. The apparatus, systems and methods are susceptible to modifications and alternative forms. The application is not limited to the particular forms disclosed. The application covers all modifications, equivalents, and alternatives falling within the spirit and scope of the apparatus, systems and methods as defined by the claims.

A tattoo is a form of body modification, made by inserting ink into the skin. A tattoo can be permanent or temporary and may be visible by reflecting light in the visible spectrum or may be invisible to the human eye by only reflecting light that is outside the visible spectrum. Tattoos are ubiquitous throughout the world. A Harris Poll wherein adults were surveyed between Jan. 16 and 23, 2012 determined that one in five U.S. adults has at least one tattoo (21%) which is up from the 16% and 14% who reported having a tattoo when this question was asked in 2003 and 2008, respectively. Tattoos are also very prevalent outside of the US.

As used in this application, the terms below have the defined meanings.

“Excitation System or Systems”—A laser, light, optical, heat, sound or other energy producing system or combinations thereof.

“Detection System or Systems”—A system used for detecting signals produced by an Excitation System or Systems.

“Vibrations” means energy interactions, in some instances this is understood to be physical motion and other instances it is understood to mean electromagnetic interaction to be an induced electrical current that “oscillates” (vibration) dependent on the energy source but then reradiates or scatters from the conductive materials.

Tattoo are made by artificially introducing material into the skin that alters the natural pigmentation of the skin such that a visual image can be semi-permanently imprinted into the skin. The ink that is used making the tattoo consists of different types of chemicals that provides different colors. While the colors are visible to the eye, the materials used in the tattoo ink also have different characteristics at different parts of the electromagnetic spectrum and have other material properties such as hardness and thermal characteristics.

In basic embodiments the inventor's apparatus, systems, and methods recognize an individual that has a tattoo using a database of known tattoos by directing energy onto or proximate the tattoo producing a signal with an enhanced image of the individual's tattoo; detecting said signal using a detecting system; and comparing said enhanced image of the individual's tattoo with the known tattoos in the tattoo database thereby recognizing the individual if the individual's tattoo matches a known tattoo in the tattoo database. Directing energy onto or proximate the tattoo provides a signal with (i) a visual image, (ii) an enhanced image with improved radiation intensity, (iii) vibrations in the tattoo or (iv) oscillations in the tattoo. Detecting the signal (i) records visual images, (ii) uses spectroscopy, (iii) detects vibrations in the tattoo or (iv) detects oscillations in the tattoo to provide said enhanced image of the individual's tattoo.

In one embodiment, electromagnetic energy is deposited on a tattoo on the individual. The energy causes metal in the tattoo to scatter the electromagnetic energy thereby causing the tattoo to act as an antenna and scatter a signal that is used for identifying, tracking, and/or monitoring. The inventors refer to metal as a specific energy coupling mechanism that is used as a signal differentiating property. More broadly, the invention uses signal contrasting compound/material.

In another embodiment, a different type of energy (such as acoustic energy) is deposited proximate the tattoo on the individual to create vibrational waves in the tissue beneath the tattoo which in turn causes the metal in the tattoo to vibrate and produce a signal that is used for identifying, tracking, and/or monitoring. The vibration of the metal in the tattoo can be detected when the vibration can, in turn, cause an effect on an optical signal, which effect can be measured and characterized and may be used as an optical signature of the tattoo.

The radiated signals are received by detection systems. The different shapes and sizes of the tattoos make the signals unique and create a “signature” of the individual with the tattoo that can be used with biometrics and artificial intelligence. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

In various embodiments, the inventor's apparatus, system and methods provide the detection, location, tracking, and/or monitoring of the individual with the tattoo.

The quality and reliability of disclosed apparatus, systems and methods is improved by combining (1) the embodiment wherein metal in the tattoo is caused to interact and (2) the embodiment wherein energy is deposited proximate the tattoo creating vibrational waves in the tissue beneath the tattoo which in turn cause the metal in the tattoo to vibrate. The disclosed apparatus, systems and methods are combined with existing biometric systems and artificial intelligence systems to provide confirmation and provide an improved system.

### Tattoos in General

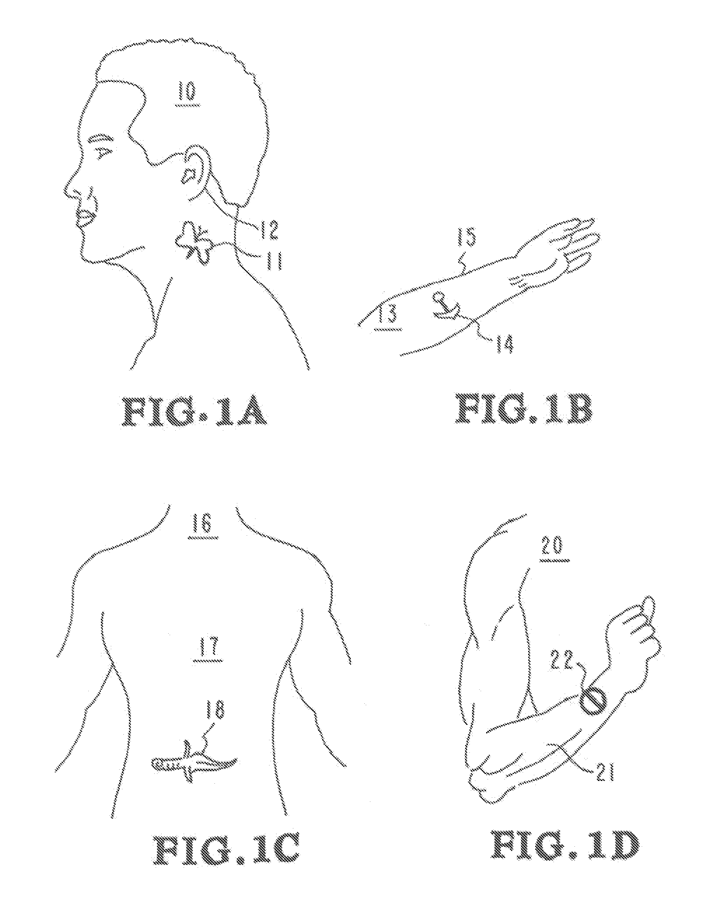

Referring now to the drawings and in particular to FIGS. 1A, 1B, 1C, and 1D wherein a number of different tattoos are illustrated. The tattoos vary widely in type, shape and location. FIGS. 1A, 1B, 1C and 1D illustrate different types and shapes of tattoos located at different locations on individual's bodies. In FIG. 1A, an individual 10 has small tattoo 12 located behind his ear 11. In FIG. 1, an individual 13 has a tattoo 14 in the shape of an anchor located on his arm 15. In FIG. 1C, an individual 16 has a tattoo 18 in the shape of a dagger located on his back 17. In FIG. 1D an individual 20 has a temporary tattoo 22 in the shape of a bar crossed circle located on his arm 21.

Commercial tattoos are made with ink that often includes metal. The ink may be made from iron oxides or metal salts. The inks can include nanoparticles. Heavy metals are used for colors and include mercury (red); lead (yellow, green, white); cadmium (red, orange, yellow); nickel (black); zinc (yellow, white); chromium (green); cobalt (blue); aluminum (green, violet); titanium (white); copper (blue, green); iron (brown, red, black); barium (white) and other metals. Metal oxides used include ferrocyanide and ferricyanide (yellow, red, green, blue). Tattoo ink manufacturers typically blend the heavy metal pigments and/or use lightening agents (such as lead or titanium) to reduce production costs.

Since the tattoo inks are injected into the body to form the tattoo, the metal in the inks inherently forms an antenna. The antenna produced by the tattoo can be considered a radiating antenna. United States Published Patent Application No. 2015/0265508 in paragraph [0031] states: “conventional permanent tattoo inks which are typically made of heavy metals.” The metal in the tattoo ink can be used to create a unique signal identifying the individual with the tattoo. An excitation system is used to deposit energy on or proximate the tattoo which causes metal in the tattoo to oscillate and the tattoo acts as an antenna sending a signal that can be detected by conventional means. Systems wherein a tattoo acts as an antenna are known. For example, United States Published Patent Application No. 20140125532 for tattooed antennas includes the statements: “The antenna system may include feed system that drives the tattooed antenna” and “The tattooed antenna may be a feed pickup antenna and/or a radiating antenna.”

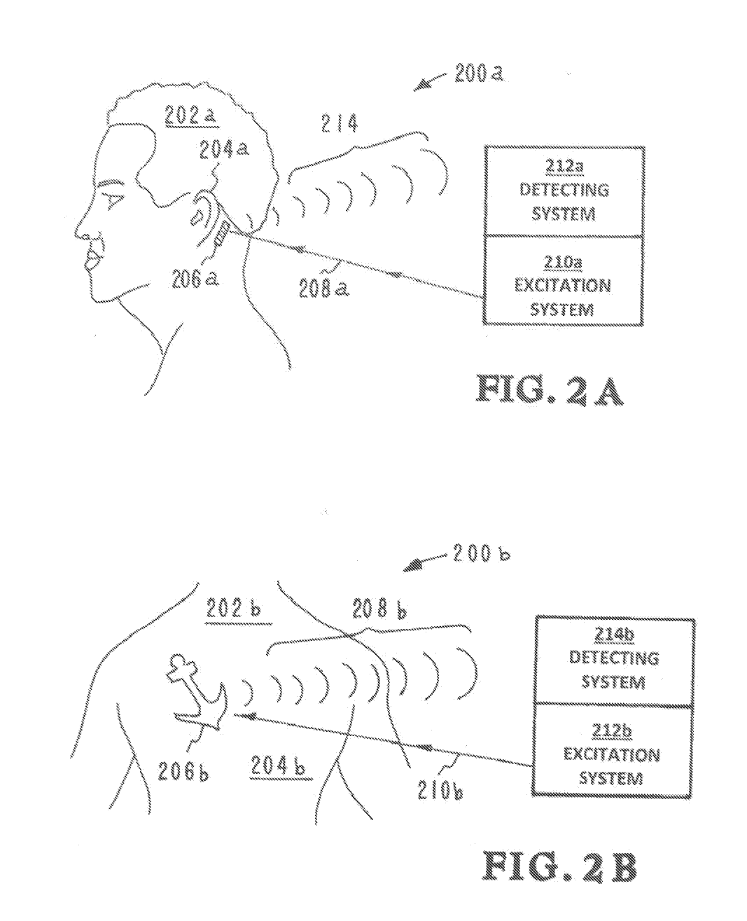

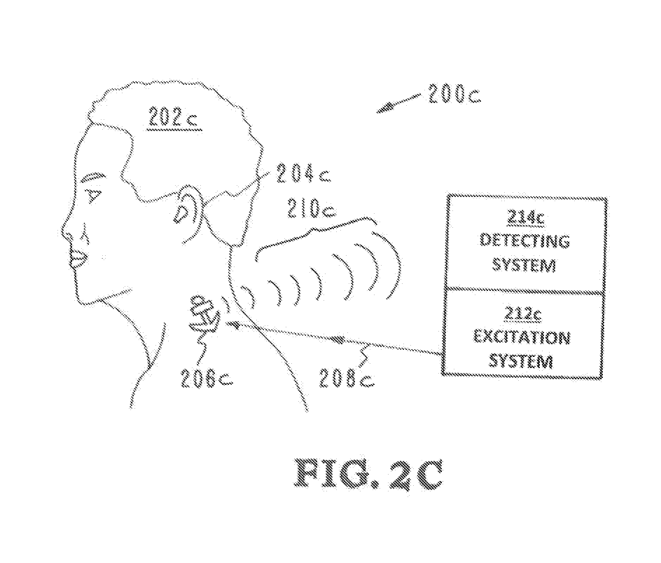

Referring now to FIGS. 2A, 2B, and 2C a number of different embodiments of the inventors' tattoo enhancement apparatus, systems and methods are illustrated. The different embodiments are designated generally by the reference numerals 200a, 200b and 200c. Implementation or demonstration the inventors' tattoo enhancement apparatus, systems and methods relies on contrast as well as uniqueness of the response and there are many other factors complicating things so the realization is complex. A body tattoo will be variable given orientation and shape of the surface which may be a function of muscle state. Significant development in both the materials used in the tattoo as well as the interaction method and signal acquisition are considered in the inventors' tattoo enhancement apparatus, systems and methods.

### FBI Tattoo Database

The FBI has a searchable database containing images of individual's tattoos. Tattoos have long been recorded by law enforcement officials during arrests or incarceration; for example, mug shots of arrestees' body art have been taken since the turn of the century. Typically, photographing tattoos resulted in investigators having to spend hours going through telephone book-size portfolios to find an image. Tattoo recognition technology aims to achieve the same result as facial recognition. In fact, plans are in place to meld the two technologies—the FBI's Next Generation Identification System calls for an automatic retrieval system for scars, marks and tattoos. The use of prisoners' tattoos in the Tatt-C project was highly controversial, as they were not freely given the ability to consent to the use of their personal identifying information. In several cases, the tattoos had names and birthdates, or were located in intimate places. With increased tattoo recognition, people can be tracked or identified while walking down the street based solely on their body art.

The National Institute of Standards and Technology (NIST) launched a program to accelerate tattoo recognition technology. In 2014 and 2015, the Institute initiated its Tatt-C program, which stands for Tattoo Recognition Technology Challenge. The project started with an FBI database containing 15,000 images of prisoner tattoos. The biometric database was shared by NIST with participating organizations to use their algorithms to create a database for law enforcement officials. New technology is giving law enforcement agencies the ability to identify people by taking a photo of their tattoo and incorporating the photo of the tattoo in a searchable database.

### Metal in Tattoo Vibrates (Interacts)

FIG. 2A illustrates an embodiment 200a of the present invention wherein energy is deposited on a tattoo on the individual, causing metal in the tattoo to oscillate and the tattoo to act as an antenna and send the signal that is used for identifying, tracking and/or monitoring. The energy deposited on the tattoo creates vibrations or oscillations in the tattoo which are detected by a detector. In one embodiment of the system 200a, an excitation system 210a is used to deposit energy 208a on a tattoo 206a behind the ear 204a of an individual 202a. The energy 208a causes metal in the tattoo ink to vibrate and produce radiated signal 214a. The detecting system 212a detects the radiated signal 214a for identification, tracking and/or monitoring of the individual with the tattoo 206a. In one embodiment, energy is applied and causes the ink to vibrate on the nanometer displacement scale. A laser signal is directed at the tattoo and the reflected signal is detected by a laser vibrometer to sense the phase changes from the reflection over that level of skin displacement. In another embodiment, energy is applied and causes the ink have a distinctive vibration and consequently localized heating. A thermal camera is positioned to pick up the heat signature.

In some cases, the amount of energy is similar to the energy being used by RFID systems, and smartphone antennas. A strong dependency is how much metal is in the tattoo ink. One important aspect is that there needs to be enough metal content to elicit a ‘reflection’ from the tattoo that is different than a ‘reflection’ from the background skin or other materials. The distance that it can work will strongly be dependent on the size of the tattoo, the feature of the tattoo that will provide a strong couple with the incident signal, and the narrowness of the incident beam of energy. Where the incident beam size is smaller than the tattoo, imaging may be possible and where the size is larger than the tattoo, the use of sensing and spectrometry are advantageous. If as an example, the incident signal is a laser beam and the vibration of the tattoo gives rise to a strong reflection of the laser beam, then a certain ink will allow the laser vibrometer (watt size or less) to be able to pick up possible micrometer/sub-micrometer differential vibrations. Such vibrations may be indicative of the presence of the tattoo hundreds of meters away.

Some of the modalities that can cause contrast between the background skin characteristics and tattooed skin characteristics include the use of heat, acoustic energy and electromagnetic radiation. Exemplary detection systems utilize laser vibrometry, laser spectroscopy, narrow band electromagnetic signals, and broadband/ultrawideband electromagnetic signals. The threshold for detection has multiple dependencies and generally the closer between the detector/sensor/imager and the tattoo, the lower the power and resolution requirements. The signals measured from the detection system will need to be processed from the raw energy form to become usable information. One utilization is that when a known subject will at some point be under authoritative control, the tattoo of the subject can be collected along with other biometric signatures such that there is a baseline for future reference. In this case, one can use a tattoo biometric database, similar to databases that include data identifying a pupil, a voice or a face.

In another embodiment, the system 200a employs one or more wavelengths of an excitation system 210a to deposit energy on the tattoo 206a. The excitation system can be a laser or RF source. The energy causes the metal in the tattoo ink to oscillate and create a signal 214a that is radiated from the tattoo 206a. The detection system 212s detects the signal 214a that has been radiated from the tattoo 206a.

### An Example of RF-Based Radar-Like Features

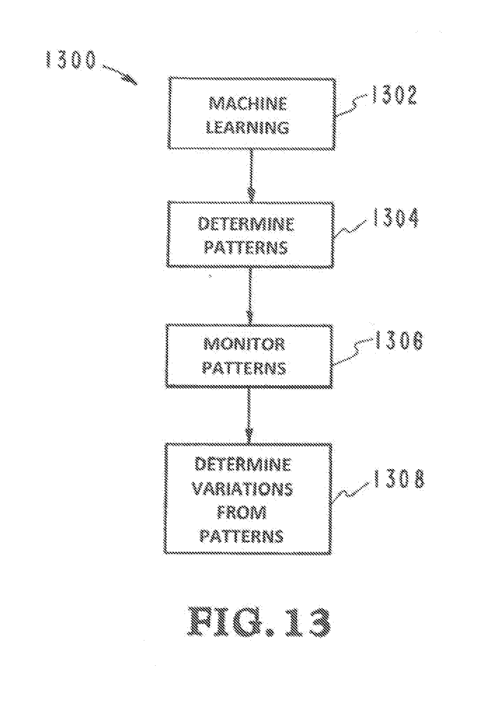

In some embodiments of the present invention, a radar system 210a, as shown, e.g., in FIG. 2A, directs radar waves 208a onto target 206a to create scattered signal 214a which is detected by detecting system 212a for localizing target 206a and its features in space and time. Radar excitation system, radar waves, target, scattered signal and detection system are also identified in FIGS. 2B-12 and FIGS. 14-17. An aspect of this scattering process is that the target scattering as a function of viewing angle is affected by the RF wavelength, RF polarization, conductive properties of the tattoo, conductive properties of the object on which the tattoo is located and the shape of the scattering object. These interactions enable a radar-like interrogation process to be used to obtain scattering features related to the tattoo. One method for analyzing the data is shown in FIG. 13. Other methods for analyzing the date will be apparent to those skilled in the art based on this disclosure.

Embodiments of the present invention use an RF wavelength that is on the order of the twice the longest dimension of the tattoo. A 6 cm tattoo dimension would suggest a frequency of 2.5 GHz. With an antenna positioned e.g., normal to the tattoo to start, using linear polarization, the antenna is physically rotated thus changing the radar wave polarization 180 degrees from the initial position, while acquiring the amplitude and phase of the scattering signal. A rotationally symmetric signal response is produced. This process is repeated with shorter RF wavelengths, gathering scattering responses from the finer structures of the tattoo, until an ensemble of scattering responses is acquired. This data can then be used for a variety of purposes such as a reference for future interrogations (e.g., a reference fingerprint) or as the result of an interrogation. Correlation analysis is then used match the unknown to the knowns in a database.

For further understanding of the process, it is helpful to consider a simple tattoo consisting of an ellipse with the long axis oriented vertically. The RF scan would be strongly reflected for a vertically-oriented antenna at the lowest frequency interacting with the long axis of the tattoo. As the antenna is rotated, the response would fall. As the frequency is increased and the antenna rotated, the response would be reduced in the vertical orientation but strongest at 90-degree rotation. Note that interrogation can be accomplished at a distance and through clothing (dielectrics). Scattering is a function of several factors, including tattoo conductivity-contrast against the tissue. Another factor is the incident angle of the RF in 3 dimensions. Energy density falls off with distance as R⁻⁴. Tattoo complexity can affect correlation.

### Vibrational Waves in Tissue Causes Metal in Tattoo to Vibrate

Referring now to FIG. 2B, an embodiment of the inventors' apparatus, systems, and method creates vibrational waves in the tissue beneath the tattoo which in turn cause the metal in the tattoo to vibrate and the vibration is turned into an optical signal. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

The system 200b employs an interrogating laser 212b to deposit energy 210b on the tissue 204b below the tattoo 206b. The energy 210b causes the tissue 204b to produce vibrational waves 208b in the tissue 204b that cause the metal in the tattoo 206b ink to vibrate. The detecting system 214b detects vibration 208b of the tattoo 206b. Vibration 208b of the tattoo 206b is utilized by the detecting system 214b. The detecting system 214b is based upon conversion of a vibrational signal to an optical signal.

Detecting systems based upon conversion of a vibrational signal to an optical signal are known. For example, U.S. Published Patent Application No. 2013/0338504 discloses a system for conversion of a vibrational signal to an optical signal as described in the sentences from the identified paragraphs of the published patent application reproduced below.

. . . “The system is based on the conversion of the vibrational signal carried by the pressure, acoustic or ultrasound wave into an optical signal via the use of a specially designed impedance matching signal converting material (IMSCM) that is applied on the surface.”

. . . “which in turn produces a corresponding change in the optical response of the composition to an interrogating light (e.g. laser or LED source operating at a suitable single or multiple wavelengths).”

The optical ultrasound detection system 214 detects the arriving waves 220 using the optical signal 218. The ultrasound waves 220 from the tissue freely propagate to the IMSCM 214 surface causing a corresponding change in the optical signal. For example, the spatial displacement of the gel 214 surface can be detected with interferometric methods. Detection of the spatial displacement of the gel 214 surface by the optical signal 218 at one or more location 214 enables increased sensitivity and volume of information.

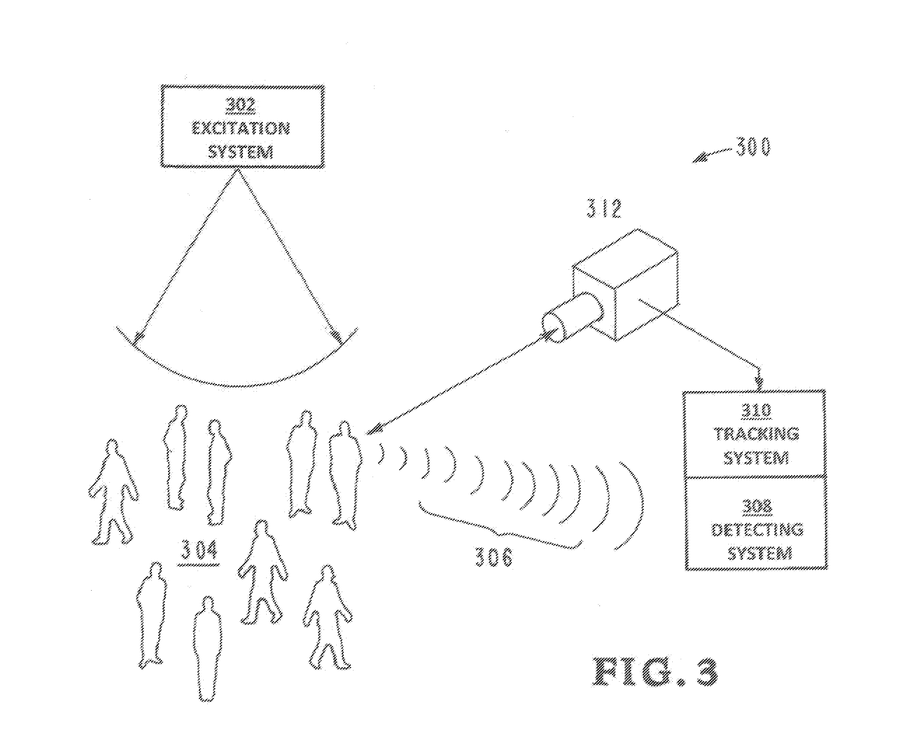

FIG. 3B is an illustration of another embodiment of the signal converting material 322 that contains two or more different types of particles such as particles 324 and larger refractive particles 326. Such arrangement is suitable to achieve a combination of optical properties for signal conversion such as for example the converting material has reflective and diffusive properties or the signal conversion can be achieved by monitoring two or more light properties such as phase, coherence, frequency, intensity etc.

### Laser Produces Vibrations in Metal of Tattoo

FIG. 2C illustrates an embodiment of the inventors' apparatus, systems and methods that creates vibrations in the tattoo which are detected by the vibrations in the tattoo being turned into an optical signal. The system 200c employs an interrogating laser 212c to deposit energy 210c on the tattoo 206c behind the ear 204c of an individual 202c. The energy 210c causes the metal in the tattoo ink to vibrate. The detecting system 214c detects vibration of the tattoo 206c. Vibration of the tattoo 206c is utilized by the detecting system 200c. The detecting system 214c is based upon conversion of a vibrational signal to an optical signal. The line 208c illustrates the use of the detecting system 214c to convert the vibrational signal of the tattoo 206c to an optical signal.

FIG. 2C is helpful to understand another embodiment where the excitation system 212C is a broadband source of electromagnetic radiation 208C. Alternately, it can be a plurality of narrowband sources of electromagnetic radiation where each source emits a different wavelength. If the tattoo 206C comprises material that will absorb light at one or more of the wavelengths of electromagnetic radiation 208C, the light that is reflected/back scattered from the tattoo will have a reduced amount of the absorbed one or more of the wavelengths. The spectrum of the reflected/back scattered light can be used to form a data representation of the tattoo. The collected signals can provide characteristic and useful information to be used in analyzing the differences between an incident signal and a reflected signal where the differences are cause by the presence of the tattoo. The differences between those signals can have dependencies in frequency/wavelength, dynamic range across frequency and time, and modulations over long periods of time. In whole, those type of signal characteristics can be combined or be used by themselves to describe the tattoo characteristics in sufficient detail to be use as identifying signatures.

### An Example of Optical Interrogation and Spectral Features

Some embodiments of the present invention use photonic approaches for interrogation and identification. For example, excitation system 210a in FIG. 2 can be a low power laser of variable wavelength which produces a beam 208a that illuminates the area of the tattoo 206a with a raster-scanning technique. The reflected and scattered photons 214 can be detected by detecting system 212a. Photons 214 are used to identify the constituents of the tattoo inks using spectroscopy. For example, detecting system 212a can be a spectroscopy system. An image could be created by converting the raster-scan position and scattering information if desired, but from a simple identification standpoint, the data could be left in a single data vector of sample number and response and can then be cross-correlated against reference data. This technique is generally not useable through opaque layers. Based on this disclosure, those skilled in the art with understand the data transformation techniques required to account for viewing angle. See e.g., scanning of QR code blocks.

### Tracking Suspected Terrorists and Criminals

Referring now to FIG. 3 an embodiment of the inventors' apparatus, systems and methods is shown monitoring a group of people that could include terrorists or criminals. The embodiment is designated generally by the reference numeral 300. The inventors' apparatus, systems and methods 300 use an excitation system 302 to deposit energy on all the individuals 304 in the group shown in FIG. 3.

One of the individuals 304 has previously been identified as a terrorist or criminal with a tattoo. The energy deposited by the excitation system 302 on the tattoo of that individual will cause metal in the tattoo to produce a signal 306. The signal 306 is detected by the detecting system 308. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

The signal 306 is produced by the excitation system 302 depositing energy on the individual's tattoo. In one version of the apparatus, systems and methods 300, the energy causes metal in the tattoo to oscillate causing the tattoo to act as an antenna and send the signal 306. In another version of the apparatus, systems and methods 300, the energy creates vibrations in the tattoo and the vibrations are turned into an optical signal 306. In yet another version of the apparatus, systems and methods 300, the energy creates vibrational waves in the tissue beneath the tattoo which in turn cause the metal in the tattoo to vibrate and the vibrations are turned into an optical signal 306.

The signal 306 is detected by camera 312, the detecting system 308, and/or the tracking system 310. The signal 306 is processed by the detecting system 308 and tracking system 310. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals. The tracking system 310 monitors movement of the individual 304 with the tattoo. The shape and size of the individual's tattoo makes the signal 306 unique and creates a “signature” identifying the individual 304 with the tattoo. The tracking system 310 provides the detection, location, and tracking of the individual 304 with the tattoo. The tracking system 310 can utilize a Global Positioning System (GPS) to provide the location and the tracking of the individual 304 with the tattoo.

A camera 312 is operably connected to the detecting system 308 and the tracking system 310. The signal 306 is a “signature” identifying the individual 304 with the tattoo and the camera 312 adds images of the individual 304 with the tattoo. The camera 312 can also be connected to a facial recognition system to provide confirmation that the individual 304 with the tattoo is the terrorist or criminal with a tattoo. The facial recognition system provides confirmation and improves the reliability and accuracy of the overall system.

### Using Artificial Intelligence to Recognize Gang Tattoos

Referring again to FIG. 3, an embodiment of the inventors' apparatus, systems and methods wherein artificial intelligence is used to recognize gang tattoos. Gang tattoos are used by gang members to show loyalty and membership in a specific gang. They also reflect the gang member's life choices and gang-related accomplishments, like their specialty areas and skills, various accomplishments. Gang tattoos can also indicate the standing of the bearer in the gang, and even the acts of violence committed by him for his gang. The symbols and markings used in a tattoo are varying and distinctive to each gang. A member gets a gang tattoo inked by another gang member or an artist who operates for the gang. An example is the notorious MS-13 gang that commits major crimes throughout the world and uses distinctive tattoos for identity. The tattoo symbols are used in graffiti and other forms of media.

The inventors' apparatus, systems and methods 300 use images of the tattoo symbols from graffiti and other forms of media to locate and monitor gang members. For example, a gang symbol in graffiti on a wall is used to identify gang members using artificial intelligence. Artificial intelligence is used to match gang members tattoos with images in graffiti on a wall.

The inventors' apparatus, systems and methods 300 use an excitation system 302 to deposit energy on all the individuals 304 in the group shown in FIG. 3. One of the individuals 304 has previously been identified as a gang member with a tattoo. The energy deposited by the excitation system 302 on the tattoo of that individual will cause metal in the tattoo to produce a signal 306. The signal 306 is detected by the detecting system 308. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

The signal 306 is detected by camera 312, the detecting system 308, and/or the tracking system 310. The signal 306 is processed by the detecting system 308 and tracking system 310. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

The tracking system 310 monitors movement of the individual 304 with the tattoo. The shape and size of the individual's tattoo makes the signal 306 unique and creates a “signature” identifying the individual 304 with the tattoo. The tracking system 310 provides the detection, location, and tracking of the individual 304 with the tattoo. The tracking system 310 can utilize a Global Positioning System (GPS) to provide the location and the tracking of the individual 304 with the tattoo.

### Tattoos Covered by Clothing

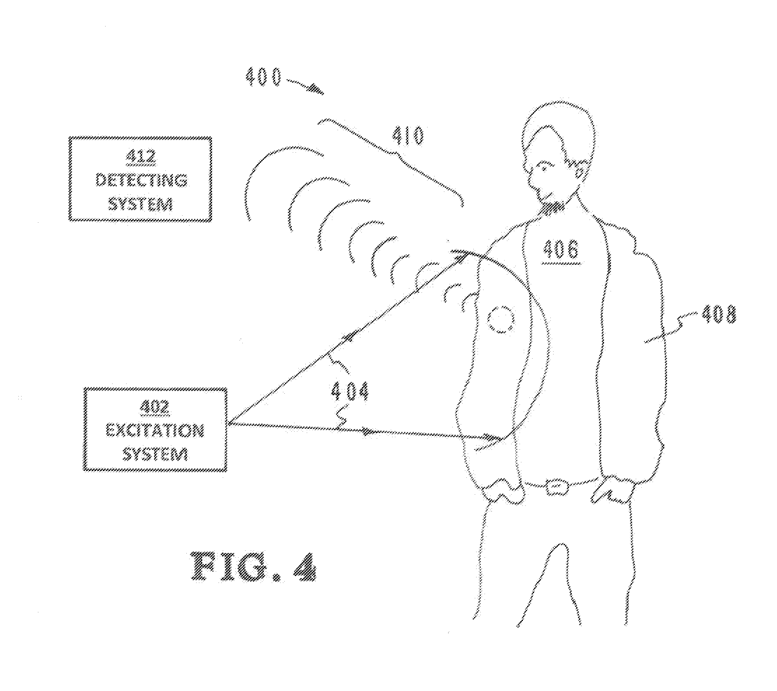

Referring now to FIG. 4 an embodiment of the inventors' apparatus, systems and methods is shown monitoring an individual with tattoos wherein the tattoos are covered by clothing. This embodiment is designated generally by the reference numeral 400. The inventors' apparatus, systems and methods 400 use an excitation system 402 to deposit energy 404 on the individual 406. The energy deposited by the excitation system 402 will cause metal in the tattoo to produce a signal 410. The signal 410 is detected by the detecting system 412. The individual 406 has clothing that covers the tattoos. The energy from the excitation system 402 and the signal 410 both pass through the individual's clothing 408. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

Tracking from a Drone

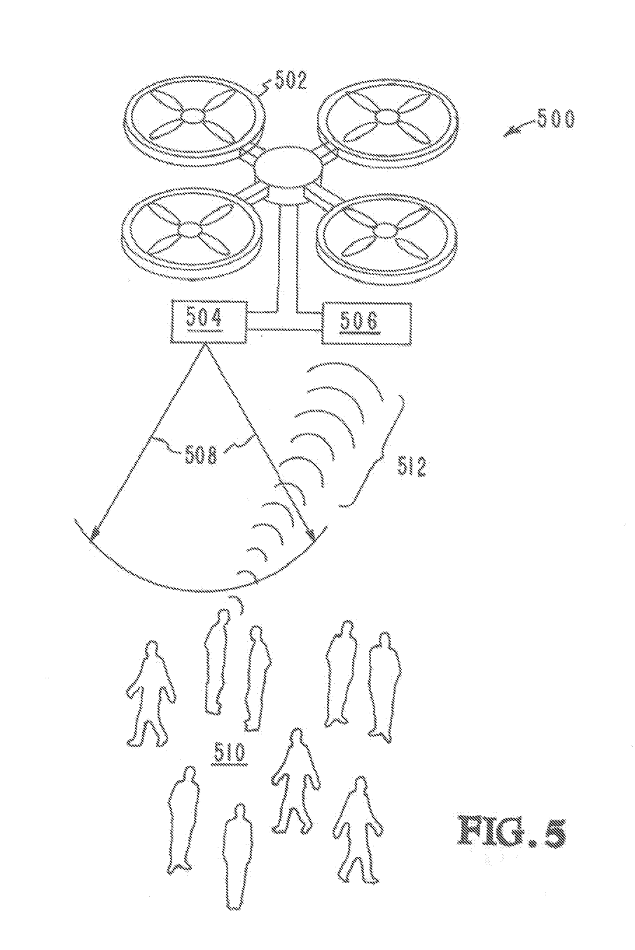

Referring now to FIG. 5 an embodiment of the inventors' apparatus, systems and methods is shown wherein a group of people are monitored from a drone. The embodiment is designated generally by the reference numeral 500. The inventors' apparatus, systems and methods 500 use an excitation system 504 carried by a drone 502 to produce an energy beam 508 that is deposited on the individuals 510 in the group shown in FIG. 5. If any of the individuals have a tattoo, the energy deposited by the excitation system 504 will cause metal in the tattoo to produce a signal 512. The signal 512 is detected by the detecting system 506 carried by the drone 502.

The signal 512 is produced by the excitation system 504 depositing energy on the individual's tattoo. In one version of the apparatus, systems and methods 500, the energy causes metal in the tattoo to oscillate causing the tattoo to act as an antenna and send the signal 512. In another version of the apparatus, systems and methods 500, the energy creates vibrations in the tattoo and the vibrations are turned into an optical signal 512. In yet another version of the apparatus, systems and methods 500, the energy creates vibrational waves in the tissue beneath the tattoo which in turn cause the metal in the tattoo to vibrate and the vibrations are turned into an optical signal 512.

The signal 512 is detected by the detecting system 506. The shape and size of the individual's tattoo makes the signal 512 unique and creates a “signature” identifying the individual 510 with the tattoo. The tracking system 506 provides the detection, location, and tracking of the individual 510 with the tattoo.

Tracking from an Airplane

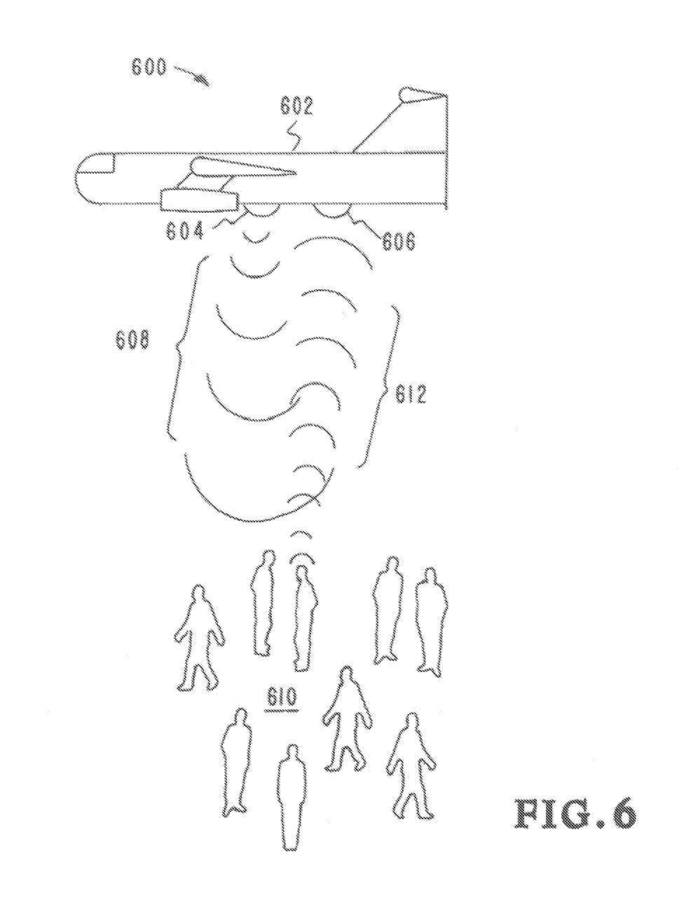

Referring now to FIG. 6 an embodiment of the inventors' apparatus, systems and methods is shown wherein a group of people are monitored from an airplane. The embodiment is designated generally by the reference numeral 600. The inventors' apparatus, systems and methods 600 use an excitation system 604 carried by an airplane 602 that produces a beam of energy 608 that is deposited on the individuals 610 in the group shown in FIG. 6. If any of the individuals have a tattoo, the energy deposited by the excitation system 604 will cause metal in the tattoo to produce a signal 612. The signal 612 is detected by the detecting system 606 carried by the airplane 602.

The signal 612 is produced by the excitation system 604 depositing energy on the individual's tattoo. In one version of the apparatus, systems and methods 600, the energy causes metal in the tattoo to oscillate causing the tattoo to act as an antenna and send the signal 612. In another version of the apparatus, systems and methods 600, the energy creates vibrations in the tattoo and the vibrations are turned into an optical signal 612. In yet another version of the apparatus, systems and methods 600, the energy creates vibrational waves in the tissue beneath the tattoo which in turn cause the metal in the tattoo to vibrate and the vibrations are turned into an optical signal 612.

The signal 612 is detected by the detecting system 606. The shape and size of the individual's tattoo makes the signal 612 unique and creates a “signature” identifying the individual 610 with the tattoo. The tracking system 606 provides the detection, location, and tracking of the individual 610 with the tattoo.

Monitoring from a Satellite

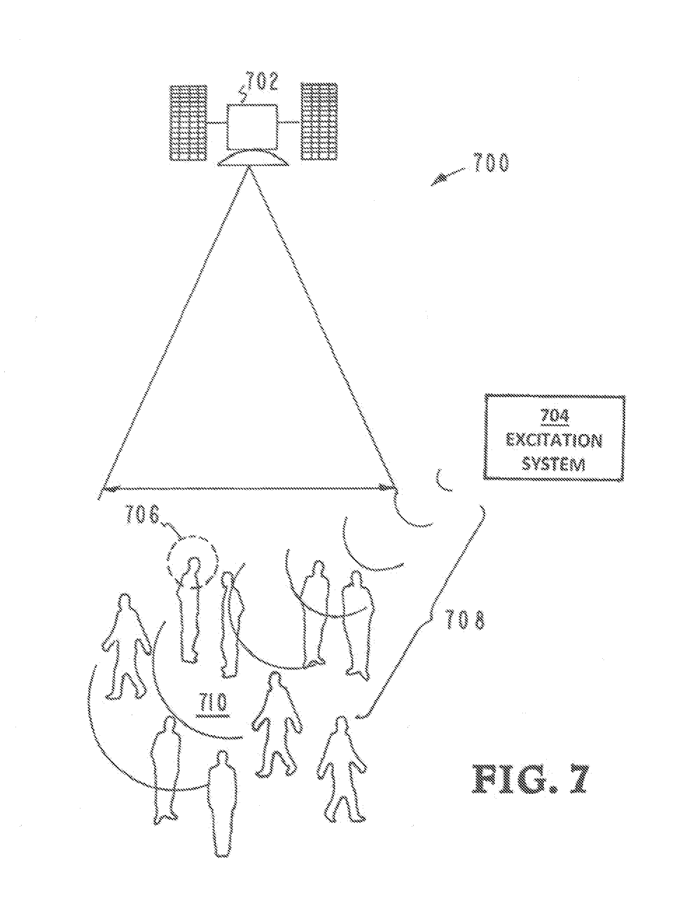

Referring now to FIG. 7 an embodiment of the inventors' apparatus, systems and methods is shown wherein a group of people are monitored from a satellite. The embodiment is designated generally by the reference numeral 700. The inventors' apparatus, systems and methods 700 use an excitation system 704 that produces an energy beam 708 deposited on the individuals 710 in the group shown in FIG. 7. If any of the individuals have a tattoo the energy deposited by the excitation system 704 will cause metal in the tattoo to produce a signal 706. The signal 706 is detected by analyzing the photos taken by the satellite 702. The shape and size of the individual's tattoo makes the signal 706 unique and creates a “signature” identifying the individual 710 with the tattoo.

The signal 706 is produced by the excitation system 704 depositing energy on the individual's tattoo. In one version of the apparatus, systems and methods 700, the energy causes metal in the tattoo to oscillate causing the tattoo to act as an antenna and send the signal 706. In another version of the apparatus, systems and methods 700, the energy creates vibrations in the tattoo and the vibrations are turned into an optical signal 706. In yet another version of the apparatus, systems and methods 700, the energy creates vibrational waves in the tissue beneath the tattoo which in turn cause the metal in the tattoo to vibrate and the vibrations are turned into an optical signal 706.

### Monitoring Crime

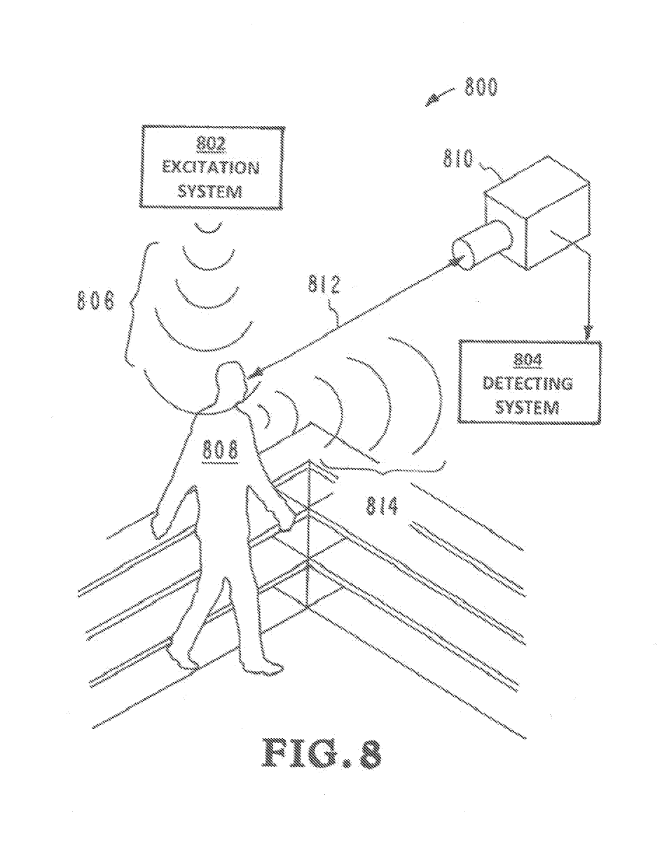

Referring now to FIG. 8, a system wherein a robbery in progress is being monitored by the inventors' apparatus, systems and methods. The system is designated generally by the reference numeral 800. In the system 800, an excitation system 802 is used deposit energy 806 on a tattoo on an individual 808 that is in the act of committing a robbery. The deposited energy will cause metal in the tattoo to oscillate and the tattoo to act as an antenna and send a signal 814. The system 800 employs one or more wavelengths of an excitation system 802 to deposit energy on the tattoo. The excitation system can be a laser or RF source. The energy causes the metal in the tattoo ink to oscillate and create a signal 814 that is radiated from the tattoo. The detection system 804 detects the signal 814 that has been radiated from the tattoo. A camera 810 is mounted so that it is focused 812 on the individual 808 that is in the act of committing a robbery. The camera 810 captures images of the individual 808 that has a tattoo. A biometric system can be used to process the images of the individual 808 to supplement the detection of the individual 808.

### Monitoring in a Security Booth

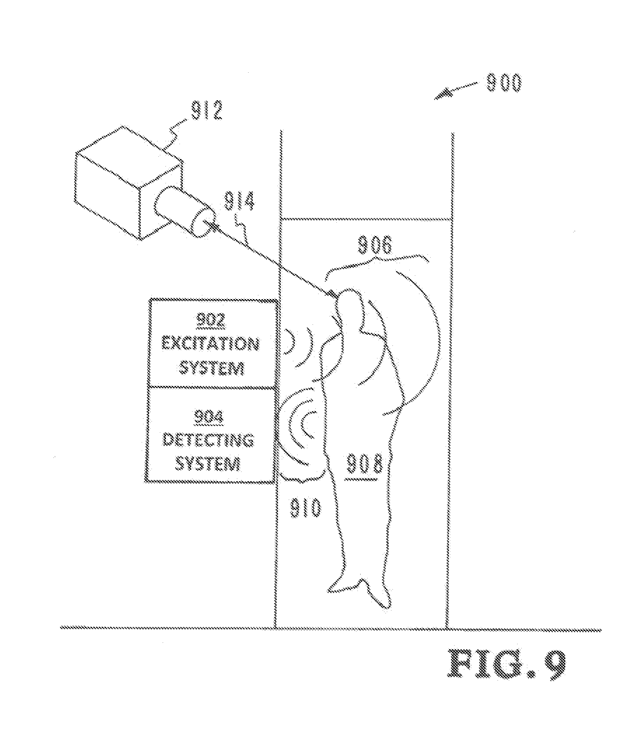

Referring now to FIG. 9, a system wherein an individual in a security booth is being monitored by the inventors' apparatus, systems and methods. The system is designated generally by the reference numeral 900. In the system 900, an excitation system 902 is used to deposit energy 906 on a tattoo on an individual 908 in a security booth. The deposited energy will cause metal in the tattoo to oscillate and the tattoo to act as an antenna and send a signal 910. The system 900 employs one or more wavelengths of an excitation system 902 to deposit energy on the tattoo. The excitation system can be a laser or RF source. The energy causes the metal in the tattoo ink to oscillate and create a signal 910 that is radiated from the tattoo. The detection system 904 detects the signal 910 that has been radiated from the tattoo. A camera 912 is mounted so that it is focused 914 on the individual 908 in the security booth.

The strength of the signal produced by the tattoo is a limiting factor in the practical application of the inventors' apparatus, systems and methods. By using the system 900 in a security booth the distance between the individual 908 and the detecting system 904 is short and the signal 910 is stronger over the shorter distance. Also, the distance between the individual 908 and the excitation system 902 is short and a reduced power excitation system 902 can be used because the distance is shorter. The inventor's apparatus, system and methods enhance the signals and improve the use of the signals for identifying, tracking, and/or monitoring individuals. The enhanced signal is coupled with biometric systems and artificial intelligence systems to improve the use of the signals for identifying, tracking, and/or monitoring individuals.

### Tracking and Locating Prisoners and Fugitives

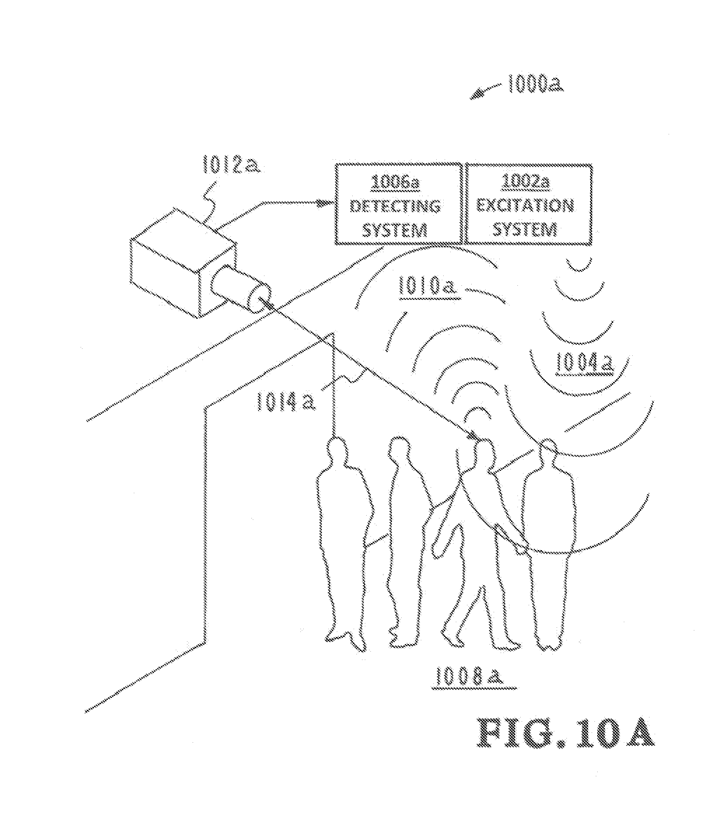

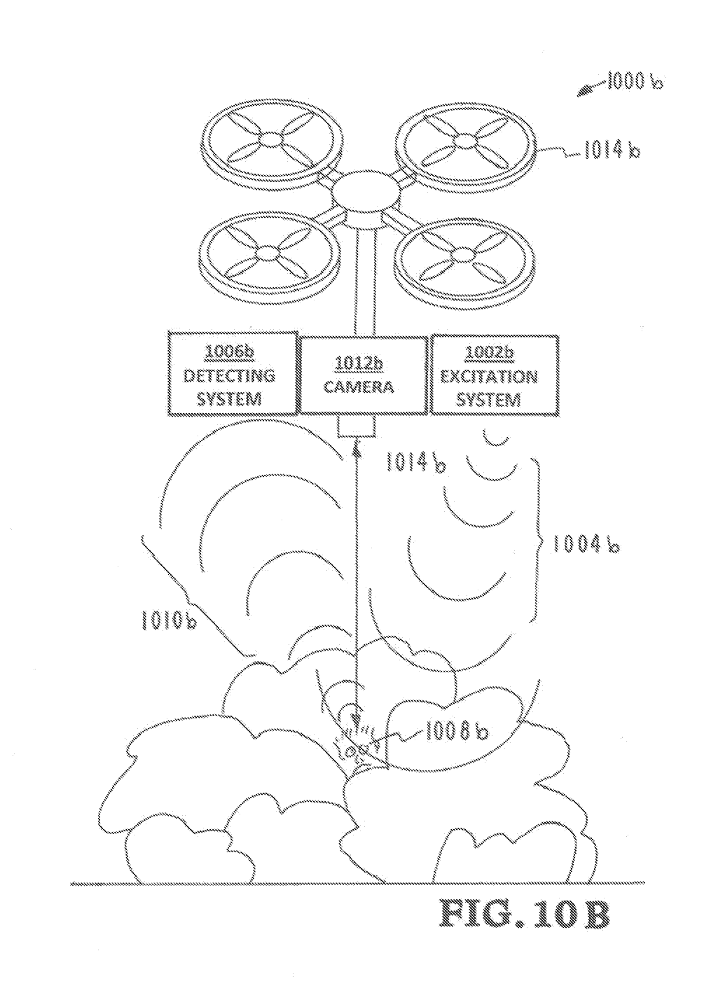

Referring now to FIGS. 10A and 10B, various embodiments of the inventors' apparatus, systems and methods are shown for monitoring and locating prisoners and fugitives. In FIG. 10A, an embodiment is shown wherein a group of prisoners is being identified and tracked by the present invention.

The embodiment is designated generally by the reference numeral 1000a. An embodiment 1000a of the present invention uses an excitation system 1002a to deposit energy 1004a on the prisoners 1008a. If any of the prisoners 1008a have a tattoo, the energy 1004a deposited by the excitation system 1002a will cause metal in the tattoo to produce a signal 1010a. The signal 1010a is detected by the detecting system 1006a.

A camera 1012a is operably connected to the detecting system 1006a. The camera 1012a produces pictures 1014a that are transmitted to the detecting system 1006a. The pictures 1014a identify the prisoner 1008a with the tattoo and the camera 1012a adds images of the prisoner 1008a with the tattoo. The camera 1012a can also be connected to a facial recognition system to provide confirmation of the identity of prisoner 1008a. The facial recognition system provides confirmation and improves the reliability and accuracy of the overall system.

The signal 1010a produced by the excitation system 1002a is a “signature” identifying the prisoner 1008a with the tattoo and the camera 1012a adds an image of the prisoner 1008a. The system 1010 monitors movement of the prisoner 1008a. The system 1000a provides the detection, location, and tracking of the prisoner 1008a using the prisoner's tattoo. The tracking system 1000a can utilize a Global Positioning System (GPS) to provide the location and the tracking of the prisoner 1008a.

Referring now to FIG. 10B, an embodiment of the present invention is shown monitoring a fugitive. The embodiment is designated generally by the reference numeral 1000b. The present invention 1000b uses an excitation system 1002b carried by a drone 1014b to deposit energy 1004b on an individual suspected of being a fugitive that is hidden 1008b in the view shown in FIG. 10B. If the individual 1008b has a tattoo the energy deposited by the excitation system 1002b will cause metal in the tattoo to produce a signal 1010b. The signal 1010b is detected by the detecting system 1006b.

The signal 1010b can be matched with a data base to determine whether the individual is the fugitive that is being sought. A camera 1012b is operably connected to the detecting system 10086b and the camera 1012b adds images of the search operation.

### Monitoring and Locating Terrorists

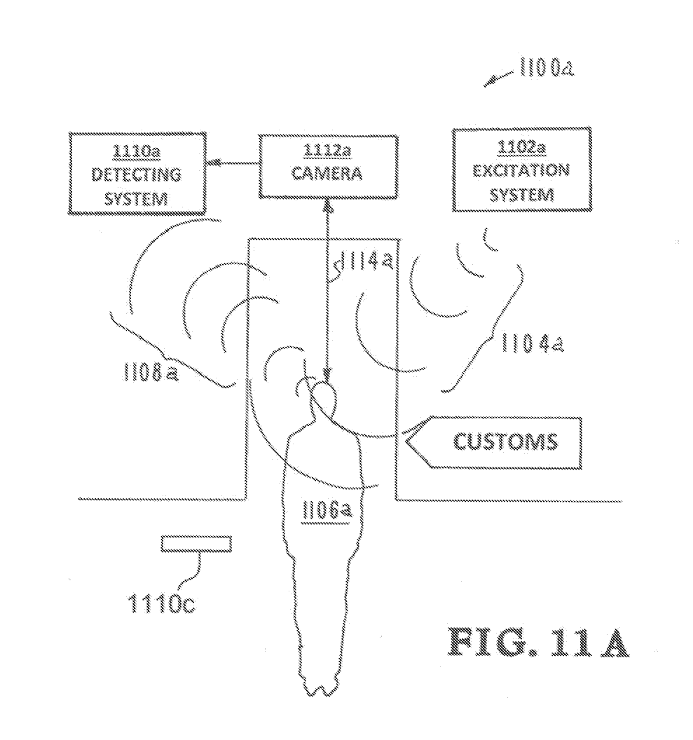

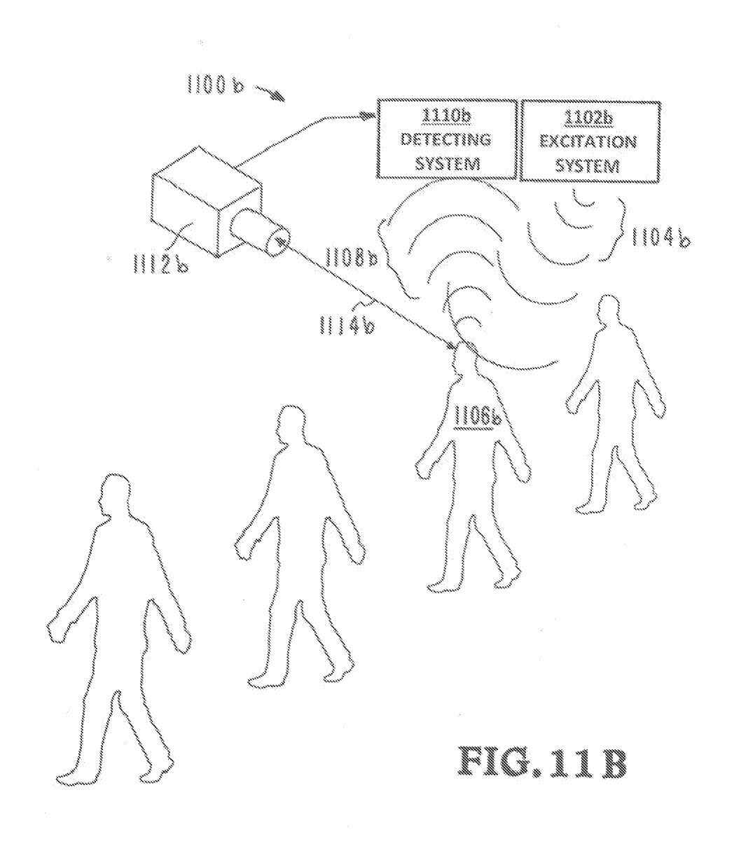

Referring now to FIGS. 11A and 11B, various embodiments of the inventors' apparatus, systems and methods are illustrated wherein terrorists are identified and tracked. In FIG. 11A an embodiment is shown wherein a suspected terrorist is being identified at customs by the inventors' apparatus, systems and methods. The embodiment is designated generally by the reference numeral 1100a.

Passport and other information can provide reason to suspect that the individual 1106a is a terrorist. The inventors' apparatus, systems and methods 1100a use an excitation system 1102a to deposit energy 1104a on the individual 1106a suspected of being a terrorist. If the individual 1106a suspected of being a terrorist has a tattoo the energy 1104a deposited by the excitation system 1102a will cause metal in the tattoo to produce a signal 1108a. The signal 1108a is detected by the detecting system 1110a. The signal 1108a radiated from the tattoo provides a “signature” assigned to the individual 1106a suspected of being a terrorist. Since each tattoo is distinctive the signal 1108a radiated from the tattoo is distinctive. The system may include a hand-held wand (reference no. 1110c) that TSA screeners sometimes use on passengers. The hand-held wand would place the detection unit close to the tattoo, better enabling detection of weak signals.

A camera 1112a is operably connected to the detecting system 1110a. The signal 1108a is a “signature” identifying the individual 1106a suspected of being a terrorist and the camera 1112a adds an image 1114a of the individual 1106a suspected of being a terrorist. The system 1100a can be used to monitor movement of the individual 1106a suspected of being a terrorist. The system 1100a can utilize a Global Positioning System (GPS) to provide the location and the tracking of the terrorist 1108a.

Referring now to FIG. 11B, various embodiments of the inventors' apparatus, systems and methods are illustrated wherein terrorists are identified and tracked. In FIG. 11B an embodiment is shown wherein a suspected terrorist has been identified at customs by the inventors' apparatus, systems and methods illustrated in FIG. 11A and wherein the system 1100b illustrated in FIG. 11B identifies and tracks the individual 1106b in other environments. The embodiment is designated generally by the reference numeral 1100b.

The inventors' apparatus, systems and methods 1100b use an excitation system 1102b to deposit energy 1104b on the individual 1106b that was suspected of being a terrorist and locating the individual 1106b in other environments. The excitation system 1102b will cause metal in the tattoo to produce a signal 1108b. The signal 1108b is detected by the detecting system 1110b. The signal 1108b radiated from the tattoo provides a “signature” assigned to the individual 1106b that was suspected of being a terrorist. Since each tattoo is distinctive the signal 1108b radiated from the tattoo is distinctive.

A camera 1112b is operably connected to the detecting system 1110b. The signal 1108b is a “signature” identifying the individual 1106b and the camera 1112b adds an image 1114b of the individual 1106b. The system 1100b can be used to monitor movement of the individual 1106b. The system 1100b can utilize a Global Positioning System (GPS) to provide the location and the tracking of the terrorist 1106b.

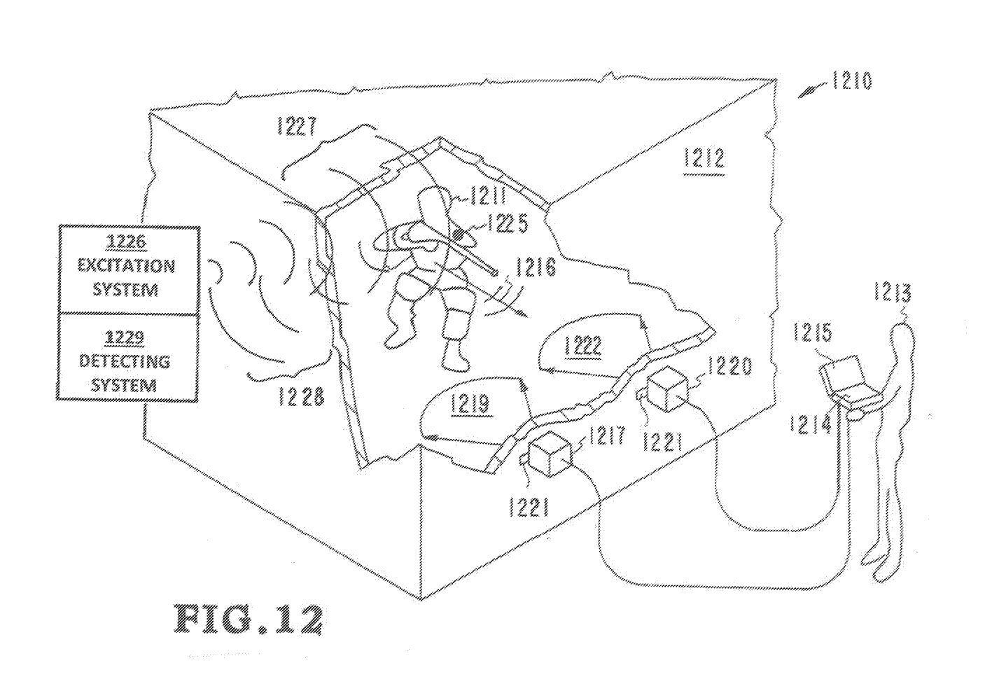

Referring now to FIG. 12, the inventors' apparatus, systems and methods are combined with an ultra-wideband (UWB) radar system for detecting and tracking through the wall of a building. An example of an ultra-wideband (UWB) radar system for detecting and tracking through the wall of a building is disclosed in U.S. Published Patent Application No. 2006/0061504. Relevant portions of the published patent application are reproduced below in the identified paragraphs.

The present invention provides a system for detecting and tracking an individual or animal. Fractional bandwidth of any radar system is defined as the radar system bandwidth divided by its center or carrier frequency. Ultra-wideband (UWB) radar is defined as any radar system that has a fractional bandwidth greater than 0.25. The radar in the system typically has a fractional bandwidth greater than 1. The system comprises producing a return or reflected radar signal from the individual or animal with a first low power ultra-wideband radar. Producing a second return or reflected radar signal from the individual or animal with a second low power ultra-wideband radar. Maintaining the first low power micro-power radar a fixed distance from the second low power ultra-wideband radar. Processing the first return radar signal and the second return radar signal in detecting and tracking of the individual or animal. One embodiment of the present invention provides a system for detection and tracking of an individual or animal comprising a first low power ultra-wideband radar unit that produces a first return radar signal from the individual or animal, a second low power ultra-wideband radar unit that produces a second return radar signal from the individual or animal, the second low power micro-power radar unit located a fixed distance from the first low power ultra-wideband radar unit, and a processing system for the first and the second return radar signal for detection and tracking of the individual or animal. Although the system is described using two radar units, third, fourth, fifth, etc. radar units may be added to enhance performance. Examples of added performance include, but are not limited to, coverage area, resolution, and signal strength.

Urban warfare, terrorism, military operations, police raids, and search and rescue efforts are becoming more and more commonplace. The detection and tracking system of the present invention will allow police, military, or rescue forces to detect the presence and location of individuals behind obstructions. The detection and tracking system will also allow rescue forces to detect and locate survivors buried in rubble at extended distances. This can be where urban infrastructures have been damaged or destroyed by man-made or natural means. The detection and tracking system can also be used in other rescue operations such as avalanches, bombs, and earthquakes. The detection and tracking system has other uses, for example the system can be used by firefighters to monitor and keep track of individual firefighters in burning buildings through obscurants such as smoke, mist, and fog.

Referring now to FIG. 6, another embodiment of detection and tracking system of the present invention is illustrated. This embodiment of the detection and tracking system is generally designated by the reference numeral 60. Urban warfare, terrorism, military operations, police raids, and search and rescue efforts are becoming more and more commonplace. The detection and tracking system 60 will allow police, military or other rescue forces to detect the presence and location of individuals behind obstructions.

The detection and tracking system 60 is capable of detecting and tracking individuals 61A and 61B at extended distances the doors 62 or other light construction material such as sheetrock, two-by-four frame construction, adobe, cinder block, brick, etc.

The detection and tracking system 60 utilizes a first radar unit 63 that provides an estimate of range to target. The first radar unit 63 provides a sweeping radar beam that provides an estimate of range to target. A second radar unit 64 provides an estimate of range to target. The second radar unit 64 provides a sweeping radar beam that provides an estimate of range to target. The second radar unit 64 gives a second, different, estimate of range to target. The first radar unit 63 and the second radar unit 64 are mounted on a frame at fixed distance apart. The first radar unit 63 and the second radar unit 64 are small, low power ultra-wideband radar units as previously described. They utilize sweeping radar beams that provide an estimate of range to target.

The frame and radar units 63 and 64 are mounted on a robot vehicle 65. The robot vehicle 65 includes a remotely adjustable arm for positioning the radar units at the desired position and height on the door 62. The robot vehicle 65 includes a central unit that controls the robot vehicle and includes a wireless unit that communicates with a remotely located central processor 66.

The detection and tracking system 60 utilizes the first radar unit 63 that provides an estimate of range to target. The first radar unit 63 provides a sweeping radar beam that provides an estimate of range to target.

A second radar unit 64 that provides an estimate of range to target is positioned a fixed distance from the first radar unit 63. The second radar unit 64 gives a second, different, estimate of range to target. The first radar unit 63 and the second radar unit 64 are connected to the processing unit 66 by wireless communication units.

The detection and tracking system 60 uses return the radar signals to track motion. The radar analog output signal is proportional to motion at a set range. Signal and image processing algorithms are performed on a standard notebook computer, embedded DSP processor or similar device. A graphical users interface for the operator will allow clear discrimination of targets in real-time as well as present a history of motion over past seconds. The detection and tracking system 60 will display dominant motion in a horizontal plane at the sensor height and motion history in real-time. The screen will be calibrated and display units of distance as well as processed radar signals will be seen as subplots.

The radar analog signals are digitized and used to triangulate and locate moving objects. The location estimate is then used to focus the radar to the location of the moving subject. A spectral estimation algorithm is then applied to provide detection and estimation of the human heartbeat and respiration signature (HRS) for that location. The radar antenna separation can be mechanically adjusted from two to tens of inches for a variety of angular resolutions. The field of view of the two radar units 63 and 64 comprises a plane parallel to the floor at or near the height of the radar antenna whose edges are determined by the antenna separation and field of view. A typical setting would provide coverage of an average sized room. All motion in the field of view is analyzed and therefore multiple people will produce multiple locations and HRS signatures. Estimates are updated thirty times per second or faster. The information is displayed on a computer monitor screen or similar device. Display consists of an image representing motion in the room with icons or image highlighting to indicate locations of human subjects. Heartbeat and respiration rate estimates are also displayed for each location.

An azimuth estimate of a moving object can be calculated by signal and image filtering algorithms using multiple frame processing, non-stationary signal processing techniques, and triangulation using methods such as the Law of Cosines. This gives the ability to track a moving object precisely in space. Tracking the object allows focusing the range gate of a radar unit continuously to the moving target. This, in turn allows the continuous integration of localized spatial motion activity. Spectral estimation techniques are then used to estimate heartbeat and respiration rates.

Many devices and inventions efficacy become limited in the presence of human motion. In medicine, EEG recorders or pulse oximetry machines are two examples. The present invention is designed to make use of motion artifacts by monitoring the differential spatial energy using ultra-wideband radar devices. This approach has clear advantages as radar has the capability to penetrate through light construction materials, such as sheetrock, two-by-four frame construction, etc. This allows motion monitoring through typical walls, doors, and other non-metallic barriers. A second advantage is that ultra-wideband radar is small, lightweight, and uses very little power.

Referring again to FIG. 12, the combined system is designated by the reference numeral 1210. The system 1210 utilizes a confirmation system for detecting and tracking individuals. An individual 1211 with a tattoo 1225 is barricaded in a structure 1212.

The combined system 1210 includes both an ultra-wideband radar system and a tattoo detecting system. The ultra-wideband radar system produces a return or reflected radar signal from an individual 1211 with low power ultra-wideband radar units 1217 and 1220 producing a return or reflected radar signal from the individual 1211. The first radar unit 1217 produces sweeping beam 1219. A detection unit 1221 detects return signals. The second radar unit 1220 produces sweeping beam 1222. A detection unit 1221 detects return signals. The first radar unit 1217 and the second radar unit 1220 are small, low power ultra-wideband radar units. An operator 1213 uses a laptop computer 1214 with a screen 1215 to monitor movement and position of the individual 1211.

The combined system 1210 includes an excitation system 1226 to deposit energy 1227 on the individual 1211. The excitation system 1226 will cause metal in the tattoo to produce a signal 1228. The signal 1228 is detected by the detecting system 1229.

Referring now to FIG. 13, the inventors' apparatus, systems and methods are combined with a machine learning system 1300. The system 1300 includes machine learning 1302, determining patterns 1304, monitoring patterns 1306 and determining variations from the patterns 1308.

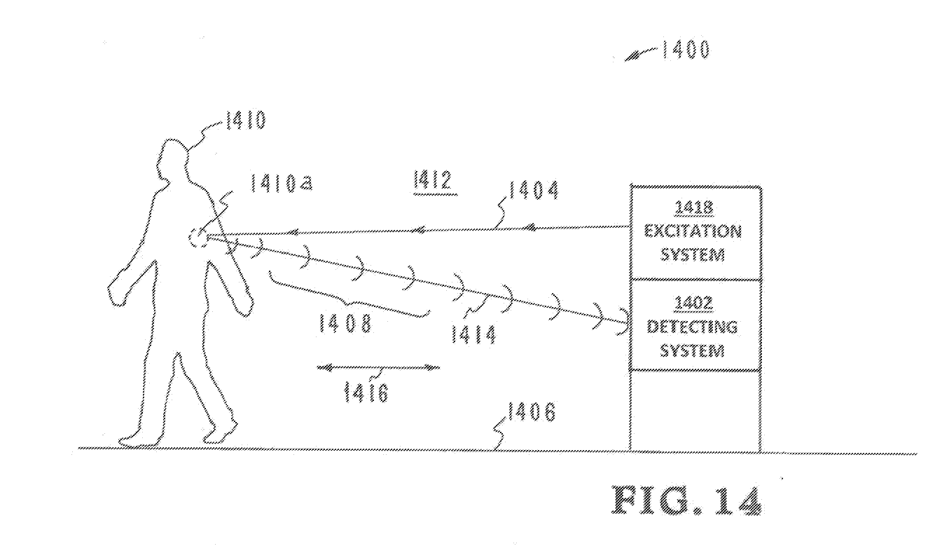

Referring now to FIG. 14, an embodiment of the inventors' apparatus, systems and methods is designated generally by the reference numeral 1412. A detector is positioned on a floor or ground 1406 at a distance 1416 from an individual 1410. The inventors' apparatus, systems and methods 1412 produces heat in the tattoo 1410a which is detected by the detector 1402. The system 1400 employs an interrogating laser 1418 to deposit energy 1404 on a tattoo 1410a of the individual 1410. The energy 1404 causes the tattoo ink to be heated. The heat energy 1408 is transmitted 1414 to the detector 1402. The detecting system 1402 detects the heat 1408 from the tattoo 1410a.

### Tracking Patients

For patients in unfamiliar, chaotic and confusing surroundings can be overwhelming and can trigger wandering tendencies causing him/her to potentially get lost, travel to unsafe areas of a facility (e.g. rooftop or balcony) or elope entirely unnoticed. A tracking system for monitoring the whereabouts of a patient is needed because patient wandering can have permanent catastrophic effects. Some of the catastrophic effects include: injury to self thereby causing pain, cuts, broken bones, and even death; injury to other patients; injury to staff; injury to the public; and other injuries. Patient wandering can have other adverse effects including: tarnished hospital reputation, liability and litigation costs, jeopardy citations, loss of Medicaid and Medicare reimbursements, spread of infection, and other adverse effects. Patients that are prone to wandering include: individuals with Alzheimer's, Dementia, Autistic spectrum disorders, patients with mental and cognitive impairments; psychiatric patients; Patients undergoing neurological surgery and other treatment; pediatric patients; and a variety of other patients.

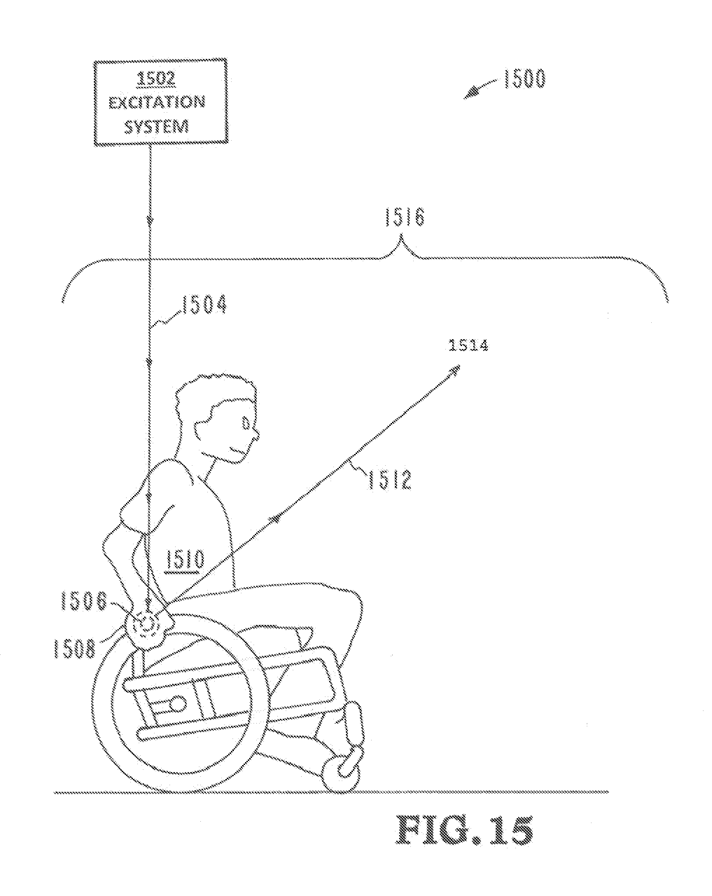

Referring now to FIG. 15, a system is illustrated for tracking a patient using a tattoo on the patient's skin and an energy source. The system is designated generally by the reference numeral 1500. A tattoo 1506 is added to a patient's skin at a visible location such as one of the patient's arms or hands. The tattoo can be temporary or permanent and may be visible by reflecting light in the visible spectrum or may be invisible to the human eye by reflecting light that is outside the visible spectrum.

As illustrated in FIG. 15, an energy source 1502 is used deposit energy 1504 on a tattoo 1506 on the hand 1508 of a patient 1510. The energy source 1502 used to deposit energy 1504 on the tattoo 1506 can be artificial or natural light in the visible spectrum. The energy source 1502 used to deposit energy 1504 on the tattoo 1506 can also be artificial invisible light outside the visible spectrum. The tattoo 1506 on the patient 1510 can be a temporary tattoo or permanent tattoo and can be visible using reflected light in the visible spectrum or invisible using reflected light outside the visible spectrum.

A detection system 1514 detects the signal 1512 that has been radiated from the tattoo 1506. The detection system 1514 will detect the signal 1512 as long as the patient 1510 remains in the monitored area 1516. The detecting system 1514 periodically scans the monitored area 1516. If the patient 1510 leaves the monitored area 1516 the detecting system 1514 will provide an alert.

The detecting system 1514 can better detect the tattoo 1506 if the tattoo 1505 has contrast with the patient's skin. The tattoo 1506 illustrated in FIG. 15 is composed of two concentric broken circles. Other shapes of tattoos can be used for other patients by making each tattoo distinctive. For example, instead of the tattoo 1506 illustrated in FIG. 15 that composed of two concentric broken circles, the tattoo 1506 can have other shapes such as a square, a cross, a single bar, a double bar, etc.

Tracking an Individual that has Alzheimer's Disease

There are 77,702,865 Baby Boomers-those born 1946-1964. An estimated 4.5 to 5 million Americans have Alzheimer's, more than double since 1980. One in ten Americans say they have a family member with Alzheimer's, and one in three know someone with the disease. With the increasing number of cases of Alzheimer's, real-time monitoring and tracking systems are need for both in-home caregivers and nursing homes alike. Every day, health service receives calls from caregivers asking for ways to more closely monitor the whereabouts of an Alzheimer patient.

With the rising cost of nursing home care for an Alzheimer patient, it is necessary to care for the patient at home. While at some point the patient will need round the clock care, the use of a monitoring and tracking system will enable the patient to stay in the comfort of their own home, with those that love them, longer and more safely.

Wandering adds more confusion to the lives of those already dealing with a disorienting disease and leads many people with Alzheimer's or dementia into unsafe situations. People with Alzheimer's don't necessarily want to be found. They won't respond to their name being called, and they'll hide anywhere, from dense woods to locked closets. New tracking technology is needed to make it easier to find those Alzheimer patients who go missing.

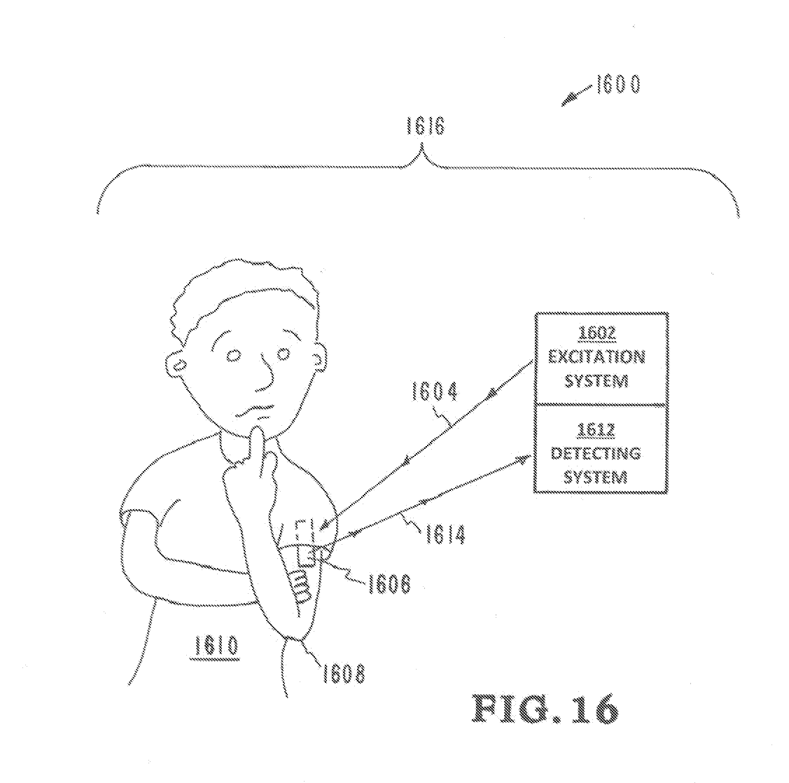

Referring now to FIG. 16, a system is illustrated for monitoring and tracking an individual 1610 with Alzheimer disease, dementia, or other debilitating disease using a tattoo on the individual's skin and an energy source. The system is designated generally by the reference numeral 1600. A tattoo 1606 is added to the individual's skin at a visible location such as one of the patient's arms or hands or at a location under light clothing. The tattoo can be temporary or permanent and may be visible by reflecting light in the visible spectrum or may be invisible to the human eye by reflecting light that is outside the visible spectrum.

As illustrated in FIG. 16, an energy source 1602 is used deposit energy 1604 on the tattoo 1606 on the arm 1608 of the individual 1610. The energy source 1602 used to deposit energy 1604 on the tattoo 1606 can be artificial or natural light in the visible spectrum. The energy source 1602 used to deposit energy 1604 on the tattoo 1606 can also be artificial invisible light outside the visible spectrum. The tattoo 1606 on the patient 1610 can be a temporary tattoo or permanent tattoo and can be visible using reflected light in the visible spectrum or invisible using reflected light outside the visible spectrum.

A detection system 1612 detects the signal 1614 that has been radiated from the tattoo 1606. The detection system 1612 will detect the signal 1614 as long as the individual 1610 remains in the monitored area 1616. The detecting system 1612 periodically scans the monitored area 1616. If the individual 1610 leaves the monitored area 1616 the detecting system 1612 will provide an alert. The detecting system 1612 can better detect the tattoo 1606 if the tattoo 1605 has contrast with the patient's skin. The tattoo 1606 illustrated in FIG. 16 is a single bar. Other shapes of tattoos can be used for other patients by making each tattoo distinctive. For example, instead of the tattoo 1606 illustrated in FIG. 16 that composed of a single bar, the tattoo 1606 can have other shapes such as a square, a cross, a double bar, a circle, etc.

In a preferred embodiment, the tattoo includes metal in the ink. The system 1600 employs an interrogating laser 1602 to deposit energy on the tattoo 1606. The energy causes the metal in the tattoo ink to vibrate. The detecting system 1612 detects vibration of the tattoo 1606. Vibration of the tattoo 1606 is utilized by the detecting system 1612. The detecting system 1612 is based upon conversion of a vibrational signal to an optical signal 1614.

### Medical Alert

Allowing an aging parent to remain at home is the “least invasive intervention” and can be successful. When people move out of their home, it is usually after problems developed such as a fall that is not discovered immediately. Home alert systems can be activated if no movement has been detected over some period of time or if a fall is detected.

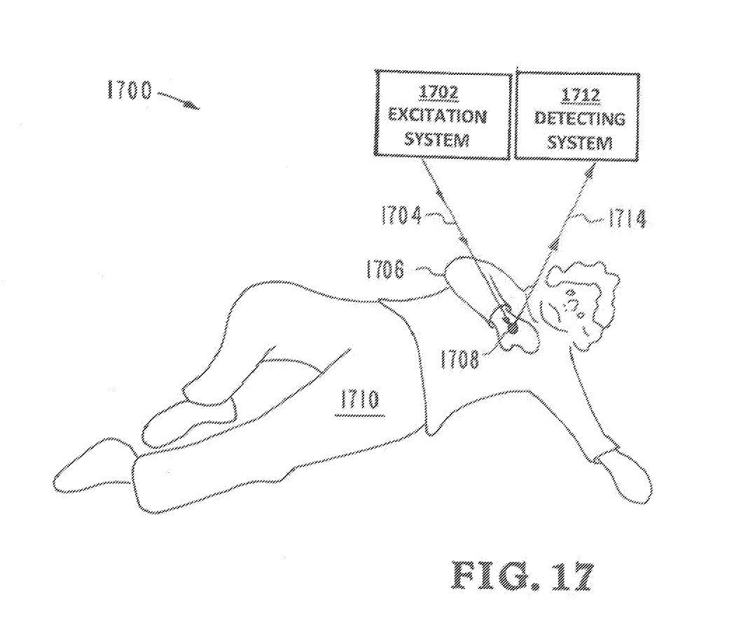

Referring now to FIG. 17, a system is illustrated for monitoring and tracking an individual 1710 living at home using a tattoo on the individual's skin and an energy source. The system is designated generally by the reference numeral 1700. A tattoo 1706 is added to the individual's skin at a visible location such as one of the patient's arms or hands or at a location under light clothing. The tattoo can be temporary or permanent and may be visible by reflecting light in the visible spectrum or may be invisible to the human eye by reflecting light that is outside the visible spectrum. In a preferred embodiment, the tattoo 1706

As illustrated in FIG. 17, an energy source 1702 is used deposit energy 1704 on the tattoo 1708 on the arm 1706 of the individual 1710. The energy source 1702 used to deposit energy 1704 on the tattoo 1708 can be artificial or natural light in the visible spectrum. The energy source 1702 used to deposit energy 1704 on the tattoo 1708 can also be artificial invisible light outside the visible spectrum. The tattoo 1708 on the patient 1710 can be a temporary tattoo or permanent tattoo and can be visible using reflected light in the visible spectrum or invisible using reflected light outside the visible spectrum.

A detection system 1712 detects the signal 1714 that has been radiated from the tattoo 1708. The detection system 1712 will detect the signal 1714 as long as the individual 1710 remains active and upright. The detecting system 1714 periodically scans the monitored area. If there is no movement of the individual 1710 detected over some period of time or if the individual 1710 moves from an upright position indicating a fall the system will detect the event. The event is then used to provide an alert.

The detecting system 1712 can better detect the tattoo 1708 if the tattoo 1708 has contrast with the patient's skin. The tattoo 1708 illustrated in FIG. 17 is an X in a circle. Other shapes of tattoos can be used for other patients by making each tattoo distinctive. For example, instead of the tattoo 1708 illustrated in FIG. 17 that composed of a X in a circle, the tattoo 1708 can have other shapes such as a square, a cross, a single bar, a double bar, etc.

In a preferred embodiment, the tattoo includes metal in the ink. The system 1700 employs an interrogating laser 1702 to deposit energy 1704 on the tattoo 1708. The energy causes the metal in the tattoo ink to vibrate. The detecting system 1712 detects vibration of the tattoo 1708. Vibration of the tattoo 1708 is utilized by the detecting system 1714. The detecting system 1714 is based upon conversion of a vibrational signal to an optical signal.

Although the description above contains many details and specifics, these should not be construed as limiting the scope of the application but as merely providing illustrations of some of the presently preferred embodiments of the apparatus, systems and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A method, comprising:
directing electromagnetic (EM) radiation onto or proximate a tattoo on an individual to produce signal radiation;
producing detected radiation from said signal radiation by utilizing at least one of spectroscopy and radar detection;
forming an image of at least a portion of said detected radiation;
providing a database of image-information of a plurality of known tattoos; and
determining if said image correlates to at least a portion of a known tattoo of said plurality of known tattoos.

2. The method of claim 1, wherein if said image does correlate to at least a portion of a known tattoo, the method further comprises determining the identity of said individual from said known tattoo.

3. The method of claim 2, further comprising tracking said individual.

4. The method of claim 1, wherein said EM radiation comprises radar waves.

5. The method of claim 1, wherein the step of determining if said image correlates to at least a portion of a known tattoo of said plurality of known tattoos includes the use of artificial intelligence.

6. The method of claim 1, wherein said EM radiation comprises radar waves, wherein said tattoo operates as a radio-frequency antenna.

7. The method of claim 1, wherein said tattoo comprises a signal contrasting material, wherein said EM radiation causes said signal contrasting material to produce said signal radiation.

8. The method of claim 1, wherein the step of directing EM radiation causes said tattoo to vibrate thereby producing a vibrating tattoo, the method further comprising directing laser light onto said vibrating tattoo to produce said signal radiation.

9. The method of claim 1, wherein the determining step utilizes at least one technique selected from the group consisting of biometric technology and machine learning technology.

10. The method of claim 1, wherein the determining step utilizes ultrawide band technology.

11. The method of claim 1, wherein said tattoo is covered by a covering, wherein the step of directing electromagnetic radiation comprises directing radiofrequency (RF) waves through said covering and onto said tattoo.

12. The method of claim 11, wherein said RF waves propagate through said covering, wherein the producing step produces detected radiation after said RF propagates through said covering.

13. The method of claim 11, wherein said covering is selected from the group consisting of clothing, foliage and building material.

14. The method of claim 1, wherein the directing step comprises directing EM radiation from an energy source located on a moveable platform.

15. The method of claim 14, wherein said moveable platform is selected from the group consisting of a land-based vehicle, a water-based vehicle, a drone, a helicopter, an airplane and a satellite.

16. The method of claim 1, wherein the directing step comprises directing said EM radiation from an energy source located on a stationary platform.

17. The method of claim 2, wherein the step of directing EM radiation comprising directing EM radiation from an energy source located on said individual.

18. The method of claim 1, wherein the step of producing detected radiation is carried out with a detector located on a moving platform.

19. The method of claim 2, further comprising collecting one or more at least partial images of said individual.

20. The method of claim 2, wherein the directing step is carried out when said individual leaves a designated area.

21. The method of claim 2, wherein said individual has been diagnosed with Alzheimer's disease.

22. The method of claim 2, wherein the step of directing EM radiation comprising directing EM radiation from an energy source located in said individual.

23. An apparatus, comprising:
an energy source configured for directing electromagnetic (EM) radiation onto or proximate a tattoo on an individual to produce signal radiation;
means for producing detected radiation from said signal radiation by utilizing at least one of spectroscopy and radar detection;
means for forming an image of at least a portion of said detected radiation;
a database of image-information of a plurality of known tattoos; and
means for determining if said image correlates to at least a portion of a known tattoo of said plurality of known tattoos.

24. The apparatus of claim 23, wherein if said image does correlate to at least a portion of a known tattoo, the apparatus further comprising means for determining the identity of said individual from said known tattoo.

25. The apparatus of claim 24, further comprising means for tracking said individual.

26. The apparatus of claim 23, wherein said EM radiation comprises radar waves.

27. The apparatus of claim 23, further comprising means for using artificial intelligence for determining if said image correlates to at least a portion of a known tattoo of said plurality of known tattoos.

28. The apparatus of claim 23, wherein said EM radiation comprises radar waves, wherein said tattoo operates as a radio-frequency antenna.

29. The apparatus of claim 23, wherein said tattoo comprises a signal contrasting material, wherein said EM radiation causes said signal contrasting material to produce said signal radiation.

30. The apparatus of claim 23, wherein if said EM radiation causes said tattoo to vibrate thereby producing a vibrating tattoo, the apparatus further comprising means for directing laser light onto said vibrating tattoo to produce said signal radiation.

31. The apparatus of claim 23, further comprising means for utilizing at least one technique selected from the group consisting of biometric technology and machine learning technology for determining if said image correlates to at least a portion of a known tattoo of said plurality of known tattoos.

32. The apparatus of claim 23, wherein if said tattoo is covered by a covering, means for directing said RF waves through said covering and onto said tattoo.

33. The apparatus of claim 32, wherein said RF waves propagate through said covering, wherein said means for producing detected radiation produces detected radiation after said RF propagates through said covering.

34. The apparatus of claim 32, wherein said covering is selected from the group consisting of clothing, foliage and building material.

35. The apparatus of claim 23, wherein said means for directing comprises an energy source located on a moveable platform.

36. The apparatus of claim 35, wherein said moveable platform is selected from the group consisting of a land-based vehicle, a water-based vehicle, a drone, a helicopter, an airplane and a satellite.

37. The apparatus of claim 23, wherein the means for directing comprises an energy source located on a stationary platform.

38. The apparatus of claim 24, wherein said means for directing comprises an energy source located on or in said individual.

39. The apparatus of claim 23, wherein said means for producing detected radiation is carried out with a detector located on a moving platform.

40. The apparatus of claim 24, further comprising means for collecting one or more at least partial images of said individual.

41. The apparatus of claim 24, wherein said means for directing is carried out when said individual leaves a designated area.

42. The apparatus of claim 24, wherein said individual has been diagnosed with Alzheimer's disease.

43. The apparatus of claim 23, further comprising means for utilizing ultrawide band technology for determining if said image correlates to at least a portion of a known tattoo of said plurality of known tattoos.

44. A method, comprising:
providing a beam of monochromatic electromagnetic radiation (EMR);
splitting said beam into a first beam and a second beam;
monitoring the intensity of said second beam;
directing at least part of said first beam onto a plurality of points on human tissue, wherein some of said EMR will be absorbed, some will be scattered and some will be reflected, wherein the portions of said EMR that are scattered and reflected are referred to herein as return EMR;
monitoring the intensity of said return EMR;
normalizing the monitored intensity of said second beam with the monitored intensity of said return EMR to produce a normalized signal;
scanning the wavelength of said EMR across a range of wavelengths that includes an absorption wavelength of a material of interest, wherein the level of said normalized signal will be reduced from unity at said absorption wavelength if said EMR comes in contact with said material of interest;
producing a two-dimensional data representation of the level of said normalized signal at said absorption wavelength at each point of said plurality of points; and
determining if said two-dimensional data representation correlates to a known tattoo.

45. A method, comprising:
providing a multiwavelength input field of electromagnetic radiation (EMR);
determining the intensity of selected wavelengths at each point of a first plurality of points across said input field to produce a separate input wavelength intensity data set for each said selected wavelength;
directing said input field onto an area of human tissue, wherein some of said EMR will be absorbed, some will be scattered and some will be reflected, wherein the portions of said EMR that are scattered and reflected are referred to herein as the return field;
determining the intensity of said selected wavelengths at each of a second plurality of points across said return field, wherein each point of said first plurality of points corresponds to a separate point of said second plurality of points to produce a separate return wavelength intensity data set for each said selected wavelength;
subtracting each said separate return wavelength intensity data set for each said selected wavelength from each corresponding said separate input wavelength intensity data set for each said selected wavelength to produce a differential data set for each said selected wavelength; and
determining if a known tattoo correlates to said differential data set.

46. An apparatus, comprising:
means for providing a beam of monochromatic electromagnetic radiation (EMR);
means for splitting said beam into a first beam and a second beam;
means for monitoring the intensity of said second beam;
means for directing at least part of said first beam onto a plurality of points on human tissue, wherein some of said EMR will be absorbed, some will be scattered and some will be reflected, wherein the portions of said EMR that are scattered and reflected are referred to herein as return EMR;
means for monitoring the intensity of said return EMR;
means for normalizing the monitored intensity of said second beam with the monitored intensity of said return EMR to produce a normalized signal;
means for scanning the wavelength of said EMR across a range of wavelengths that includes an absorption wavelength of a material of interest, wherein the level of said normalized signal will be reduced from unity at said absorption wavelength if said EMR comes in contact with said material of interest;
means for producing a two-dimensional data representation of the level of said normalized signal at said absorption wavelength at each point of said plurality of points; and
means for determining if said two-dimensional data representation correlates to a known tattoo.

47. An apparatus, comprising:
means for providing a multiwavelength input field of electromagnetic radiation (EMR);
means for determining the intensity of selected wavelengths at each point of a first plurality of points across said input field to produce a separate input wavelength intensity data set for each said selected wavelength;
means for directing said input field onto an area of human tissue, wherein some of said EMR will be absorbed, some will be scattered and some will be reflected, wherein the portions of said EMR that are scattered and reflected are referred to herein as the return field;
means for determining the intensity of said selected wavelengths at each of a second plurality of points across said return field, wherein each point of said first plurality of points corresponds to a separate point of said second plurality of points to produce a separate return wavelength intensity data set for each said selected wavelength;
means for subtracting each said separate return wavelength intensity data set for each said selected wavelength from each corresponding said separate input wavelength intensity data set for each said selected wavelength to produce a differential data set for each said selected wavelength; and
means for determining if a known tattoo correlates to said differential data set.
